(19) United States
(12) Patent Application Publication
(10) Pub. No.: US 2011/0274994 A1
(43) Pub. Date: Nov. 10, 2011

(54) Catalyst and Liquid Combination for a Thermally Regenerative Fuel Cell

(76) Inventors: Andrew J. Carrier, Trenton (CA); Boyd R. Davis, Kingston (CA); Philip G. Jessop, Kingston (CA); Keith Hao-Kiet Huynh, Kingston (CA)

(21) Appl. No.: 13/102,840

(22) Filed: May 6, 2011

Related U.S. Application Data
(60) Provisional application No. 61/332,395, filed on May 7, 2010.
(60) Provisional application No. 61/419,681, filed on Dec. 3, 2010.

(51) Int. Cl. H01M 8/18; C01B 3/32

(52) U.S. Cl. 429/419; 423/648.1

(57) ABSTRACT

Combinations of catalyst and compound are described that are suitable for use in a thermally regenerative fuel cell. Such combinations offer greater than 99% selectivity and accordingly they cycle through a reversible dehydrogenation process with substantially no loss due to byproduct formation. Combinations of secondary benzylic alcohols and Pd/SiO₂ catalysts offer levels of by-products that are undetectable by NMR and GC analysis. With such TRFC, thermal energy can be converted into electric energy in a moving vehicle without the requirement of storage of H₂, and its safety issues. Instead, a catalytic amount of H₂ is cycled through the system and used to generate electric energy.

### FIELD OF THE INVENTION

The field of the invention is energy transformation, and specifically the conversion of heat into electricity by way of a thermally regenerative fuel cell.

### BACKGROUND OF THE INVENTION

Electrical energy on board a moving vehicle such as a truck, car or ship is expensive because it cannot be obtained from a municipal electrical grid. In a moving vehicle, electrical energy must be stored using batteries or must be generated. Devices that generate electricity (e.g., an alternator) result in decreased fuel efficiency. However, there is waste heat energy available in most moving vehicles. Instead of efficiently converting gasoline or diesel's energy content into motion of the vehicle, an engine block and exhaust system inefficiently converts a large portion of gasoline or diesel's energy content into waste heat. There is a need for a method of converting waste heat into usable electrical energy inside a vehicle to supplement electrical energy available from batteries or an alternator and, if the alternator is dispensed with, to provide improved fuel efficiency.

### SUMMARY OF THE INVENTION

In a first aspect, the invention provides a method of power generation comprising:
   providing a closed system comprising:
   (a) a dehydrogenation reactor that holds a catalyst and a liquid that comprises X^{H} and X;
   (b) a fuel cell that comprises a membrane electrode assembly that comprises an anode, a cathode, and a polymer electrolyte membrane in functional contact with both the anode and the cathode; and
   (c) means for circulating fluid between the dehydrogenation reactor and the fuel cell;

heating the dehydrogenation reactor to a first temperature effective to form (a) a gaseous product that comprises H₂ and (b) a liquid product mixture that is enriched in X;

heating the fuel cell to a second temperature effective to form a liquid product mixture that is enriched in X^{H} and to generate current, wherein the second temperature is substantially lower than the first temperature;

circulating the liquid product mixture that is enriched in X from the dehydrogenation reactor to the cathode;

circulating the gaseous product of the dehydrogenation reactor to the anode; and

circulating the resulting liquid product mixture that is enriched in X^{H} from the fuel cell to the dehydrogenation reactor;

wherein thermal energy is converted into electric energy via said dehydrogenation/hydrogenation and electric current is produced by the closed system; and

wherein the dehydrogenation/hydrogenation is reversible.

In an embodiment of the first aspect, the invention provides a method of power generation comprising: providing a closed system comprising: (a) a dehydrogenation reactor that holds a catalyst and a liquid that comprises X^{H} and X; (b) a fuel cell that comprises a membrane electrode assembly that comprises an anode, a cathode, and a polymer electrolyte membrane that is in functional contact with the anode and the cathode; and (c) means for circulating fluid between the dehydrogenation reactor and the fuel cell; heating the dehydrogenation reactor to a first temperature effective to form (a) a gaseous product that comprises H₂ and (b) a liquid product mixture that is enriched in X; heating the fuel cell to a second temperature effective to form a liquid product mixture that is enriched in X^{H} and to generate current, wherein the second temperature is substantially lower than the first temperature; circulating the liquid product mixture that is enriched in X from the dehydrogenation reactor to the cathode; circulating the gaseous product of the dehydrogenation reactor to the anode; and circulating the resulting liquid product mixture that is enriched in X^{H} from the fuel cell to the dehydrogenation reactor; wherein thermal energy is converted into electric energy via said dehydrogenation/hydrogenation and electric current is produced by the closed system; and wherein the dehydrogenation/hydrogenation is reversible.

In a second aspect, the invention provides a power generator comprising: a housing; a dehydrogenation reactor that holds a catalyst and a liquid that comprises X^{H} and X; a fuel cell that comprises a membrane electrode assembly that comprises an anode, a cathode, and a polymer electrolyte membrane that is in functional contact with the anode and the cathode; and means for circulating dehydrogenation products from the dehydrogenation reactor to the fuel cell and for circulating hydrogenation products from the fuel cell to the dehydrogenation reactor; wherein the power generator is a closed system; and wherein when the dehydrogenation reactor is heated to a first temperature effective to form (a) a gaseous product comprising H₂ and (b) a liquid product mixture that is enriched in X, and the fuel cell is heated to a second temperature effective to form a liquid product mixture that is enriched in X^{H}, the first temperature being substantially higher than the second temperature, then thermal energy is converted into electric energy via reversible dehydrogenation/hydrogenation and electric current is produced.

In certain embodiments of the first and second aspects, substantially all of the X^{H} that is dehydrogenated forms X and H₂.

In a third aspect, the invention provides use of a secondary benzylic alcohol to generate electric energy from thermal energy in a thermally regenerative fuel cell (TRFC).

In a fourth aspect, the invention provides a method of dehydrogenating a secondary benzylic alcohol in a H₂-rich environment, comprising: contacting a secondary benzylic alcohol with Pd on SiO₂ in a closed H₂-rich environment at about 200° C.

In certain embodiments of the first and second aspects, X^{H} may comprise a secondary benzylic alcohol. Further, in certain embodiments, X^{H} may comprise a compound of formula (1)

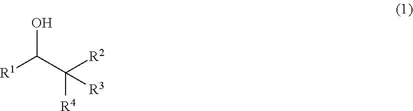

where R¹ is a substituted or unsubstituted aryl (which includes heteroaryl comprising N, O, and/or S); R², R³ and R⁴ are independently hydrogen, aliphatic, aryl, OH, OR⁵, Si, NH, NHR⁵, NR⁵R⁶, B, and may be substituted but do not include moieties that poison catalysts or that are reactive in the presence of catalyst or H₂; R⁵ and R⁶ are independently hydrogen, aliphatic, aryl, or a combination thereof; and where any combination of R², R³ and R⁴ together with the carbon atom to which they are attached, can optionally form a cyclic moiety, and R⁵ and R⁶ together with the nitrogen atom to which they are attached, can optionally form a cyclic moiety.

In certain embodiments of the third aspect, the secondary benzylic alcohol may be a compound of formula (1) as described above.

In certain embodiments of the first, second or third aspects involving one or more compounds of formula (1), R¹ may be a substituted or unsubstituted moiety selected from phenyl, pyridyl, pyrimidinyl, pyrazinyl, triazinyl, furyl, thiophenyl, imidazolyl, oxazolyl, pyrrolyl, naphthyl, quinolinyl, isoquinolyl, indenyl, indolyl, and benzothiophenyl.

In certain embodiments of the first or second aspects, X^{H} may comprise 1-phenyl-1-ethanol, 1-phenyl-1-propanol, 1-(4-methylphenyl)ethanol, 1-phenyl-2-methyl-1-propanol, or a combination thereof.

In certain embodiments of the first or second aspects, X^{H} may comprise 1-phenyl-1-propanol, which dehydrogenates to form propiophenone and H₂.

In certain embodiments of the first or second aspects, X^{H} may comprise 1-phenyl-1-ethanol, which dehydrogenates to form acetophenone and H₂.

In certain embodiments of the first or second aspects, the heating of the dehydrogenation reactor to a first temperature and the heating of the fuel cell to a second temperature may be by solar heat, waste heat, or geothermal heat.

In certain embodiments of the first or second aspects, the first temperature may be about 140 to about 300° C. and the first temperature is at least about 50° higher than the second temperature.

In certain embodiments of the first or second aspects, the first temperature may be about 180 to about 250° C. and the first temperature is at least about 50° higher than the second temperature.

In certain embodiments of the first or second aspects, the second temperature may be about 70 to about 160° C. and the second temperature is at least about 50° lower than the first temperature.

In certain embodiments of the first or second aspects, the second temperature may be about 80 to about 105° C. and the second temperature is at least about 50° lower than the first temperature.

In certain embodiments of the first or second aspects, the catalyst may be palladium on SiO₂. In certain embodiments, the catalyst may be 5% palladium relative to SiO₂.

In certain embodiments of the first or second aspects, the catalyst is Pd on carbon, Pt on carbon, or a combination of Pd and Pt on carbon. In certain embodiments, the catalyst comprises Pd on carbon. In certain embodiments, the catalyst comprises Pt on carbon.

In certain embodiments of the first, second or third aspects involving one or more compounds of formula (1), R¹ may be a substituted or unsubstituted heteroaryl moiety.

In certain embodiments of the first, second or third aspects involving one or more compounds of formula (1), the ring atom of R¹ that links to the alcohol moiety may be a carbon.

In an embodiment of the first aspect, the catalyst comprises Pd on carbon, Pt on carbon, or a combination thereof.

In embodiments of the first and second aspects, the membrane electrode assembly comprises an anode; a cathode; and a polymer electrolyte membrane in functional contact with both the anode and the cathode. In certain embodiments, the polymer electrolyte membrane comprises sulfonated polybenzimidazole. In some embodiments the sulfonated polybenzimidazole comprises a sulfonated polybenzimidazole of the following formula:

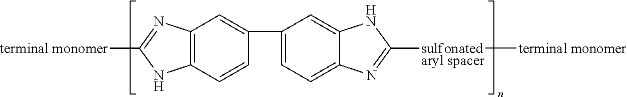

where n is a very large number, “terminal monomer” refers to the appropriate mono-linked carboxylic or diamino monomers, and non-limiting examples of sulfonated aryl spacers include:

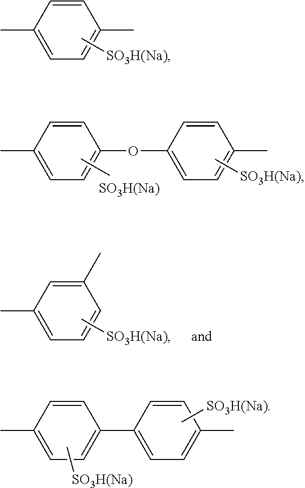

In certain embodiments of the first and second aspects, the second temperature is about 120° C. to about 160° C.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 shows a schematic of a TRFC that uses reversible dehydrogenation of a liquid X^{H} to form X and H₂.

FIG. 2 shows a plot of composition versus time for dehydrogenation of 1-phenyl-1-propanol to form propiophenone, indicating the disappearance of 1-phenyl-1-propanol (Δ), appearance of propiophenone (◯), and no by-product formation (□, propylbenzene).

FIG. 3 shows a plot of amount of 1-phenyl-1-propanol versus time for dehydrogenation of 1-phenyl-1-propanol (∇) and hydrogenation of propiophenone (◯) at 200° C.

FIG. 4 shows a table and plot of experimental results for an amount of propiophenone (%) versus time (min) for the dehydrogenation of 1-phenyl-1-propanol (over 0.1 mol % of 5 wt % Pd on SiO₂ relative to the 1-phenyl-1-propanol) under a H₂ atmosphere. The table states a rate of >3.61 L H₂ per min and per kg of 1-phenyl-1-propanol, a current of ˜600 amperes per kg of 1-phenyl-1-propanol, potential of 0.150 V and a selectivity of >99.9%.

FIG. 5 shows a plot of amount of conversion to unsaturated product versus time for three benzylic alcohols that were reacted at 200° C. over 0.1 mol % Pd/SiO₂. The lowest rate is observed with benzyl alcohol (□), followed by 1-phenyl-1-propanol (Δ), and the best rate observed was for 1-phenyl-1-ethanol (◯).

FIG. 6 shows a plot of log (k_{X}/k_{H}) versus σₚ, where log (k_{X}/k_{H}) means logarithm of the ratio of the rate constant for hydrogenation of a para-substituted propiophenone to the rate constant for hydrogenation of propiophenone, and where σₚ is the para Hammett sigma parameter.

FIG. 7 shows a schematic of an MEA having a polymer electrolyte membrane interspersed between an anode and a cathode.

### DETAILED DESCRIPTION OF EMBODIMENTS

Aspects of the invention provide a combination of a liquid and a catalyst for use in a thermally regenerative fuel cell (TRFC). Traditional fuel cells for use in vehicles require H₂ as an energy source, so that large amounts of H₂ must be stored on-board the vehicle. This presents significant disadvantages because all practical methods for storing such amounts of H₂ in a vehicle require much more volume of storage space than would be required for the storage of gasoline or diesel. If the volume of space allotted to H₂ storage in the vehicle is restricted to the volume that would otherwise be taken by a gasoline tank, then the amount of H₂ stored is so little that the vehicle will be incapable of travelling a reasonable distance. For this reason, the concept of a H₂-fueled fuel cell for supplying power in a vehicle has fallen out of favor. Advantageously, the present invention does not require large amounts of H₂ to be stored in the vehicle because H₂ is not the energy source for the fuel cell. Heat (e.g., waste heat from a gasoline-powered or diesel-powered engine block, geothermal heat, electric heat) is the energy source for the fuel cell. The heat generates H₂ and X in the dehydrogenation reactor, reaction of H₂ and X powers the fuel cell and produces X^{H} again, and then H₂ and X are regenerated again in a reactor. Therefore the amount of H₂ is constantly being regenerated, negating the need for storing H₂ in the vehicle. This has advantages, compared to a normal fuel cell system, in terms of saving space and reduced risk of H₂ flammability. Once operating, the fuel cell may be self-heated by the heat of the hydrogenation reaction going on inside it. Before it is self-heated, it may be heated by any source of heat. Non-limiting examples of heat sources include an electric heater that may be powered by a battery or another power source, solar, waste heat, or geothermal heat.

### Definitions

The following terms will be used in the following description:

As used herein, the term “thermally regenerative fuel cell” or “TRFC” is used in regard to an electrochemical cell that converts a source fuel into an electrical current wherein the source fuel is reformed by an application of heat.

As used herein, the term “X^{H}” refers to a liquid that can be dehydrogenated.

As used herein, the term “X” refers to a liquid that can be hydrogenated.

As used herein, the term “dehydrogenation” is a chemical reaction that involves the elimination of hydrogen (H₂). It is the reverse process of hydrogenation. Although it is unusual to perform a dehydrogenation reaction in the presence of added H₂ gas, such experiments were conducted herein to ensure the reaction efficiency under conditions that would be encountered in the dehydrogenation reactor of an operating TRFC.

As used herein, the term “hydrogenation” refers to a chemical reaction involving an addition of hydrogen (H₂) to a molecule. Hydrogenation processes are usually employed to reduce or saturate organic compounds. The net result of this process typically constitutes the addition of pairs of hydrogen atoms to a molecule, although the mechanism for the process may involve either simultaneous addition or stepwise addition of each H atom in a pair. Hydrogenation differs from protonation or hydride addition: in hydrogenation, the products have the same charge as the reactants.

As used herein, the term “dehydrogenation reactor” refers to a location in a TRFC where the dehydrogenation reaction occurs.

As used herein, the term “kieselghur” refers to a powder typically used for polishing, formed from shells of microscopic organisms.

As used herein, the term “substantially higher” distinguishing the difference between two temperatures refers to a difference of at least about 50° C., and optionally more. The term “substantially lower” as used herein to distinguish the difference between two temperatures refers to a difference of at least about 50° C., and optionally more.

As used herein, the term “substituents that poison catalysts” may include sulfur. However, in certain embodiments, sulfur as a heteroatom in a ring is not expected to poison catalysts.

As used herein, the term “substantially all” when used in reference to chemical reaction's selectivity refers to at least 99%. So when it is stated that “substantially all of the X^{H} that is dehydrogenated forms X and H₂” it means some portion of X^{H} is converted (e.g., conversion of 79%) and of this converted portion, at least 99% is converted to the desired product (X and H₂), and there is little to no side-product (i.e., undesired product) formation. Analogously, as used herein, the term “high selectivity” of a chemical reaction refers to generation of desired product(s) with substantially no undesired product(s).

As used herein, the term “fluid” refers to a substance that is capable of flowing. It may be, for example, a liquid, a gas, or a combination of a liquid and a gas.

As used herein, the term “aryl” refers to a moiety including a substituted or unsubstituted aromatic ring, including heteroaryl moieties and moieties with more than one conjugated aromatic ring.

As used herein “unsubstituted” refers to any open valence of an atom being occupied by hydrogen.

As used herein “substituted” refers to having one or more substituent moieties whose presence does not interfere with the desired reaction.

As used herein, “heteroatom” refers to non-hydrogen and non-carbon atoms, such as, for example, O, S, and N.

“Alcohol” means a molecule of the formula ROH, where R is typically aliphatic, aryl, or other organic moiety.

As used herein, the term “aliphatic” refers to hydrocarbon moieties that are straight chain, branched or cyclic, may be alkyl, alkenyl or alkynyl, and may be substituted or unsubstituted.

“σₚ” represents the para Hammett sigma parameter, which quantifies substituent effects by describing a linear free-energy relationship relating reaction rates and equilibrium constants for many reactions involving benzoic acid derivatives with para-substituents to each other with just two parameters, a substituent constant and a reaction constant (Hammett, Louis P. J. Am. Chem. Soc. (1937) 59: 96).

### Embodiments

A TRFC can be used to generate electrical energy from heat through a reversible reaction. As described herein, experiments have been conducted to identify catalyst/liquid combinations suitable for a thermally regenerative fuel cell. In an aspect of the invention, a suitable working liquid and catalyst combination is provided that allows for selective and rapid reversible dehydrogenation for use in a thermally regenerative fuel cell. Investigations described herein determined that reversible dehydrogenation of a liquid at temperatures substantially above 100° C. can be so selective that it is possible to use it as a basis for a TRFC.

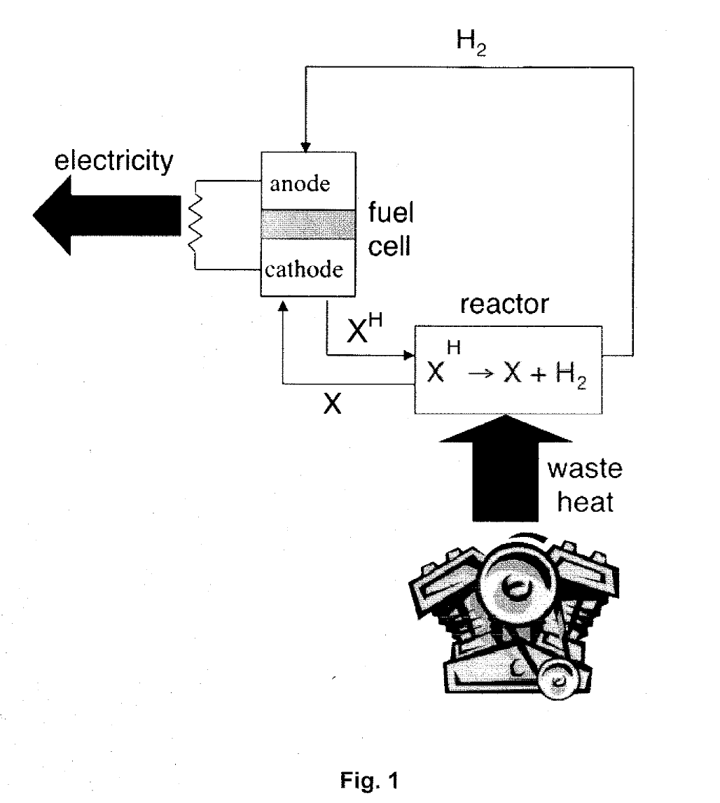

In a TRFC, a catalyst and a dehydrogenatable liquid (see “X^{H}” in FIG. 1) are placed in a dehydrogenation reactor that is located near a heat source. Such a heat source may be an engine block of a vehicle. Heat energy from the heat source drives an endothermic dehydrogenation reaction of the dehydrogenatable liquid from its saturated form (X^{H}) to give H₂ and the liquid's unsaturated form (“X” in FIG. 1). Absorbed heat is stored in chemical bonds as chemical potential energy. This reaction typically does not proceed to completion. The H₂ gas then escapes from the dehydrogenation reactor through an exit for gasses, and is passed or pumped to an anodic side of a fuel cell. The unsaturated liquid X, possibly mixed with unreacted X^{H} and dissolved H₂ gas, would pass or be pumped to a cathodic side of a fuel cell. The fuel cell would be maintained at a temperature lower than that of the dehydrogenation reactor, so that the equilibrium (i.e., equilibrium constant) would be different in the fuel cell than in the dehydrogenation reactor. In the fuel cell, at its lower temperature, the equilibrium favors hydrogenation of X to form X^{H} so that the liquid mixture leaving the fuel cell would be enriched in X^{H}. Again, this reaction would typically not go to completion. This hydrogenation would normally only release the absorbed heat that is stored as energy in chemical bonds in the form of heat, but because the hydrogenation is carried out in a fuel cell, a significant portion of the energy contained in the chemical bonds is released as usable electrical energy in the form of an electric current through an external circuit and an electric potential (voltage) across the electrodes/electrolyte membrane of the fuel cell (see a general description of a TRFC in Ando, Y. et al. Energy Conversion and Management (2001) 42: 1807-1816).

In some embodiments of the invention, solvent (e.g., water) or other unreactive diluents(s) is added to the X^{H}/X liquid. In certain embodiments, corrosion inhibitors that are unreactive under the TRFC conditions are present. In certain embodiments, other modifiers or additives are added to the liquid in order to modify its physical properties. Effects of such modifiers or additives may include increasing rate or selectivity of the hydrogenation and dehydrogenation reactions, or increasing longevity of the liquid, the membranes, or the dehydrogenation catalyst. In certain embodiments, additives are bases such as basic alkali metal salts.

Catalyst selection and stability are important parameters both in determining rates of dehydrogenation and hydrogenation (and therefore the maximum possible electric current in the fuel cell) and selectivity of the reaction (determining the cycle life of the liquid). A molecule of dehydrogenatable liquid X^{H} is required to have at least one, though it may have several, reactive sites that can undergo reversible hydrogenation. At least one of these sites, though in molecules with multiple reactive sites not necessarily all, undergoes dehydrogenation in the dehydrogenation reactor of the TRFC. This dehydrogenation reaction is endothermic and requires a catalytic species to be present and sequestered in the dehydrogenation reactor. Both the dehydrogenation and hydrogenation reactions must proceed at ambient or near ambient pressures of hydrogen and in some cases without flushing of any purge gas. The liquid itself may be composed of a single chemical compound or it may be a mixture of compounds, either all active with respect to dehydrogenation or in a mixture with compounds that do not undergo dehydrogenation in the dehydrogenation reactor. Such inactive compounds may include diluents such as solvents. Ideally the liquid is composed of a thermally stable material that is inexpensive and is of low toxicity. Because the liquid is used in a closed loop, the gravimetric hydrogen storage capacity (i.e., weight % of releasable hydrogen) of the liquid may be lower than the hydrogen storage capacity of a liquid intended for hydrogen storage. Unsaturated liquid X is preferably capable of being re-hydrogenated without need for elevated pressures of H₂.

Dehydrogenation in the dehydrogenation reactor and hydrogenation in the fuel cell must both operate with very high selectivity, so that the liquid may be used for weeks or months without replacement. For example, 99% selectivity, which is normally considered to be quite acceptable in organic synthesis, is not considered to be acceptable in a TRFC. If the selectivities of the hydrogenation and dehydrogenation reactions were 99% and if complete conversion were obtained in both reactions, then 1% of the active components of the liquid, which comprises X and X^{H}, is converted to undesired byproduct after each reaction, assuming complete conversion. Since a complete cycle of the liquid requires hydrogenation and dehydrogenation, then 2% of the active components of the liquid would be converted to undesired byproduct after each cycle. For 10 cycles per hour, then 20% of the active components would be converted to undesired byproduct every hour. The liquid would therefore have to be replaced after only approximately two hours of use. That would not be acceptable in practice. If the conversion is not complete in both reactions, then the amount of production of undesired byproduct would be less every cycle. Nevertheless, production of undesired byproduct needs to be minimized. Therefore, we have conducted experiments to identify combinations of reversibly dehydrogenatable liquid X^{H} and catalysts that provided dehydrogenation and hydrogenation in very high selectivity, meaning selectivity substantially greater than 99%. To our knowledge, there are no examples in the literature where a dehydrogenation with a selectivity substantially greater than 99% is disclosed.

Note that it is conventional in chemical research, if the selectivity is between 99% and 100%, to state that the selectivity is >99%, rather than specifying a number between 99 and 100%. This is because the accurate quantification of small amounts of byproduct requires extra effort and the use of analytical equipment with lower detection limits than ¹H NMR spectroscopy. Some researchers, not knowing this convention, may report a selectivity of “100%” in this situation, but such report means the same thing as a report of a selectivity of “>99%” (i.e., that the selectivity is high but the researcher did not choose to use an analytical method with the ability to detect and quantify the amount of byproduct). Thus, when considering reports of “100%” or “>99%” selectivity, it is important to consider which analytical method was used and its limitations. Such reports may in fact have insufficient data in regard to byproduct formation to make a determination as to whether the selectivity was much greater than 99%.

As described herein, experiments have been conducted to evaluate several kinds of liquids to determine whether they may serve as satisfactory saturated liquids X^{H} or as satisfactory unsaturated liquids (X). Generally, we evaluated the dehydrogenation of the saturated liquid X^{H}, but in certain cases hydrogenation of the unsaturated liquid X was also tested. Notably, there were several candidate combinations of catalyst and liquids that provided excellent selectivity. Such liquids comprised X^{H} compounds of formula (1):

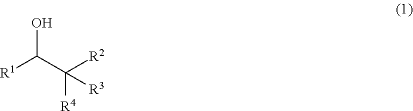

where R¹ is a substituted or unsubstituted aryl (which includes heteroaryl comprising one or more N, O, or S heteroatom(s)); R², R³ and R⁴ are independently hydrogen, aliphatic, aryl, OH, OR⁵, Si, NH, NHR⁵, NR⁵R⁶, B, or a combination thereof, but do not include moieties that poison catalysts or that are reactive in the presence of catalyst or H₂, R⁵ and R⁶ are independently hydrogen, aliphatic, aryl, or a combination thereof. Optionally, any combination of R², R³ and R⁴ together with the carbon atom to which they are attached can form a cyclic moiety. Optionally, R⁵ and R⁶ together with the N atom to which they are attached can form a cyclic moiety. Either R⁵ or R⁶ and any one of R², R³, and R⁴, along with the atoms to which they are attached may form a cyclic moiety. In certain embodiments, R¹ is a substituted or unsubstituted moiety selected from phenyl, pyridyl, pyrimidinyl, pyrazinyl, triazinyl, furyl, thiophenyl, imidazolyl, oxazolyl, pyrrolyl, naphthyl, quinolinyl, isoquinolyl, indenyl, indolyl, and benzothiophenyl. Preferred embodiments of liquids comprising compounds of formula (1) have boiling points significantly above 200° C. Preferred embodiments of liquids comprising compounds of formula (1) have freezing points that are sufficiently low to prevent freezing under regular operating conditions. Preferred embodiments of liquids comprising compounds of formula (1) have boiling points significantly above 200° C. and freezing points that are sufficiently low to prevent freezing under regular operating conditions. Preferably, the freezing point of the liquid or liquid mixture is sufficiently low to prevent the TRFC's liquids from freezing even at extreme conditions of its location/environment. Use of embodiments of the invention that include water in the liquid mixture should take into consideration whether temperatures will approach the water's freezing point (i.e., 0° C.) so as to avoid damage to the TRFC. Sufficiently selective catalyst/liquid combinations included liquids comprising compounds of formula (1). Non-limiting examples of such combinations include: palladium on silica catalyst and an X^{H} of 1-phenyl-1-propanol (whose dehydrogenation product is propiophenone); palladium on silica catalyst and 1-phenyl-1-ethanol (whose dehydrogenation product is acetophenone); palladium on silica catalyst and 1-(4-methylphenyl)ethanol (whose dehydrogenation product is methylacetophenone); and palladium on silica catalyst and 1-phenyl-2-methyl-1-propanol (whose dehydrogenation product is isobutyrophenone). Structural formulae of these liquids are shown in Table 1. Data regarding these selective combinations is presented in Table 2. Discovery of such efficient combinations was a result of much study, and many investigations uncovered non-selective liquid/catalyst combinations. For comparison purposes and to indicate how many unsuccessful combinations were studied to uncover that secondary benzylic alcohols hold promise for use in TRFCs, Table 3 is included herein. Table 3 shows results of studies of catalyst/liquid combinations that were insufficiently selective, and that were rejected from further study. Details regarding all of the studies are described in the Working Examples.

### 1-Phenyl-1-propanol and propiophenone

In an embodiment of the invention, a compound of formula (1) is 1-phenyl-1-propanol, which is a secondary benzylic alcohol. Both 1-phenyl-1-propanol and its dehydrogenation product, propiophenone (see Example 4), have boiling points significantly above 200° C. 1-Phenyl-1-propanol, propiophenone, and byproducts are easily distinguished by ¹H-NMR spectroscopy. When heated to 200° C. under an atmosphere of hydrogen gas and over a catalytic metal, 1-phenyl-1-propanol reacts rapidly. The rate of reaction and the selectivity of product formation depend on the nature of the catalyst used (see Tables 2 and 3). For example, nickel metal supported on kieselghur led almost exclusively to an undesired hydrogenolysis product, propylbenzene. Palladium gave excellent reaction rates at a metal loading of 0.1% mole equivalent with respect to the alcohol loading. Palladium on activated carbon and palladium on alumina gave poor selectivity for propiophenone, but palladium on silica gave excellent selectivity for propiophenone. With palladium on silica, no hydrogenolysis product was observed by NMR spectroscopy, so a more sensitive analytical method was required. Gas chromatography was used to detect any unwanted products. Initial gas chromatography results indicated that the selectivity for the product was at least 99.94%. However, it should be noted that the nature of the palladium on silica catalyst is important in determining its reactivity. Use of a catalyst prepared by reducing palladium metal onto mesoporous silica monoliths resulted in a loss of selectivity and end capping accessible silanol groups with silanes did not improve this result. A commercial catalyst (5% on silica powder, reduced, dry, Escat™ 1351 available from Strem Chemicals, Inc. Newburyport, Mass., USA) that was used was palladium on amorphous silica and worked well, as did a catalyst prepared by reducing palladium salts onto amorphous silica pellets (see Example 8). See Tables 2 and 3 for experimental results.

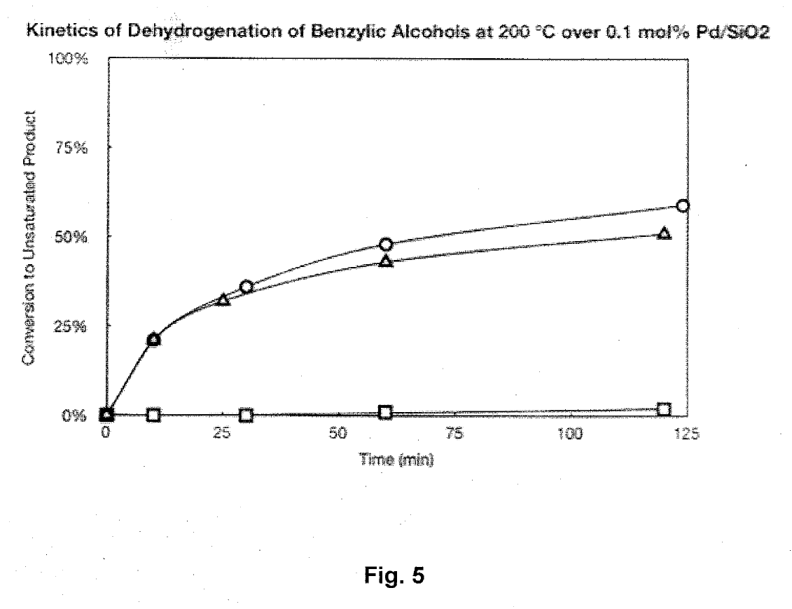

In another embodiment of the invention, a compound of formula (1) is 1-phenyl-1-ethanol. This secondary benzylic alcohol was examined as a potential dehydrogenatable liquid X^{H}, because it is slightly less sterically encumbered about the reactive site. The dehydrogenation of 1-phenyl-1-ethanol was slightly faster than that of 1-phenyl-1-propanol (see FIG. 5), and it exhibited very high selectivity. No byproduct was observable by ¹H NMR spectroscopy, but the quantification by gas chromatography has not yet been performed.

In some embodiments of the invention, aromatic ring R¹ of a compound of formula (1) is substituted. Substitution of this ring increases the rate of the dehydrogenation of the alcohol moiety to a ketone or increases the rate of hydrogenation of the ketone to alcohol. For example, a methyl group in the para position of the phenyl ring, as found in, for example, 1-(4-methylphenyl)ethanol and 1-(4-methylphenyl)1-pentanol, increased the rate of hydrogenation of its ketone to an alcohol (see Table 2).

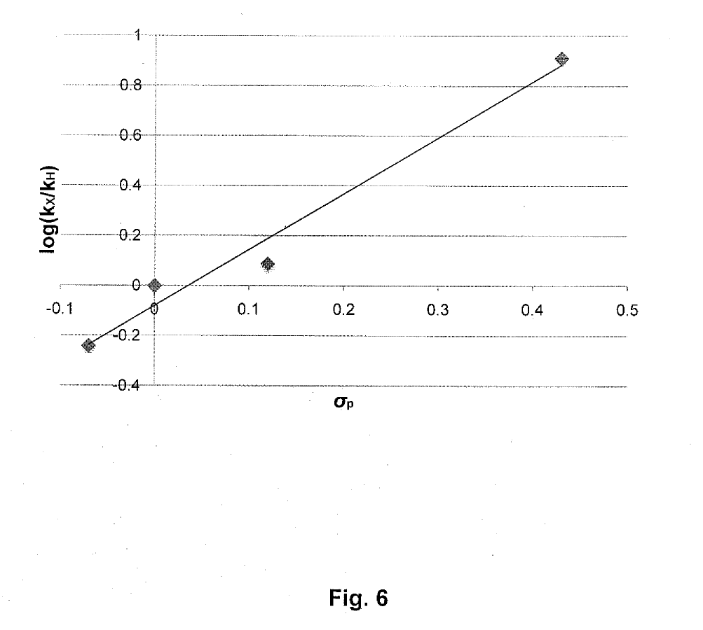

It has also been shown that including an electron-withdrawing substituent at the para position of an aryl group at R¹ increased the rate of hydrogenation of the ketone (the dehydrogenation product of the compound of formula (1)). The hydrogenation reaction was performed at 100° C. for a number of substituted propiophenones with 1 mol % palladium loading of 5 wt % palladium on silica, reduced. The conversion was measured for each reaction after 1 h. Overall rates were assumed to be indicative of the initial rates, and were plotted against the para Hammett sigma parameter (σₚ) for the substituent as seen in FIG. 6. Results show that electron-withdrawing substituents enhance the rate of the propiophenone derivative hydrogenation reaction over palladium on silica. Similar results are expected for other catalysts with similar structures of X/X^{H}. The observed selectivity for many of the experiments described herein remained >99.9% by ¹H NMR spectroscopy, as indicated in the tables.

### Screening of Catalysts for the Dehydrogenation

Catalytic screening experiments were performed to determine the ideal catalyst that would provide the highest possible selectivity (preferably greater than 99.9% and most preferably greater than 99.99%) for the dehydrogenation of 1-phenyl-1-propanol to propiophenone. High selectivities for the dehydrogenated product are essential to maintain the activity of the system over several weeks, before replacing the liquid becomes necessary. Generating substantial amounts of non-reactive by-products during the dehydrogenation reaction would decrease the concentration of the active species, 1-phenyl-1-propanol and propiophenone, resulting in a decrease in the electrical current generated by the fuel cell.

Heterogeneous catalysts, not homogenous, were chosen for screening. The nature of homogeneous catalysts would require that they be dissolved in the liquid and circulate with the liquid throughout the system. This would not be preferable for several reasons. First, if H₂ generated during the dehydrogenation reaction is not adequately separated from dehydrogenated product, then as the catalyst and liquid cycle together through the system to the fuel cell and encounter regions of lower temperature, there may be a shift in the dehydrogenation equilibrium that allows partial hydrogenation of the product, even without the use of the fuel cell. Subsequently, less current and voltage would be generated by the fuel cell. Second, the homogeneous catalyst could interfere with the heterogeneous catalyst in the fuel cell, possibly inhibiting it or rendering it inactive. Third, the homogeneous catalyst is unlikely to be as long-lasting as a heterogeneous catalyst. Lastly, the homogeneous catalyst would be lost when the liquid is replaced.

Transition metal-based heterogeneous catalysts were investigated. Palladium, platinum, rhodium and ruthenium catalysts were almost exclusively considered due to their well-established activity with respect to dehydrogenation reactions. A wide range of catalytic supports was investigated in tandem. The use of supports increases the surface area of the catalyst, rendering it more reactive, and will often have favorable or unfavorable effects on catalytic activity and selectivity. Varying the nature of the support from basic (i.e., calcium carbonate, CaCO₃), to neutral (i.e., carbon, C), to acidic (i.e., silica, SiO₂), makes it possible to investigate the subsequent effect on the electronic nature of the metal catalyst. Basic and acidic supports can be electron donating or withdrawing, respectively, and therefore could affect the catalytic activity or selectivity of the reaction to favor either the formation of propiophenone or an unwanted by-product. Supports were also chosen based on their expected chemical inertness and insolubility under the reaction conditions described herein.

Results of catalyst screening are listed in Tables 2 and 3. All ruthenium and rhodium catalysts were eliminated as viable catalysts due to their consistently poor selectivity for propiophenone. The viability of platinum as a catalyst is limited to choice of support. Platinum on silica was the only platinum catalyst tested thus far that offered a selectivity of >99% to form propiophenone, suggesting that acidic supports are necessary to obtain the desired selectivity with platinum. Conversion with platinum on silica is very poor, however, which may be a function of surface area of this particular sample of platinum on silica or an inherently low activity of platinum on silica with respect to the dehydrogenation of 1-phenyl-1-propanol.

Palladium catalysts consistently provided better selectivity and conversion than the other catalysts tested, regardless of support, with Pd on SiO₂, Pd on BaCO₃, Pd on CaCO₃.Pb, and Pd on PEI/SiO₂ (where PEI is polyethyleneimine) offering the best selectivities at >99.9% for propiophenone. Of these catalysts, Pd on SiO₂ offered the best conversion at 49%, followed by Pd on polyethyleneimine/SiO₂ at 38%. Pd on BaCO₃ and Pd on CaCO₃.Pb offer the poorest conversions at 27.3%. Although not wishing to be bound by theory, to explain these differences, some insight may be offered by comparing the catalysts' respective surface areas. Pd on SiO₂ has the highest surface area, followed by Pd on polyethyleneimine/SiO₂, then Pd on BaCO₃ and Pd on CaCO₃.Pb. Having the highest surface area, it follows that Pd on SiO₂ would have the best conversion, though other factors are potentially also involved.

In some embodiments, presence of a small amount of catalyst poison may be preferable. For example, experiments with various amounts of selenium in a Pd/SiO₂ catalyst (described in Example 9 and Table 4) showed that a small amount of selenium increased selectivity of 1-phenyl-1-propanol without greatly decreasing the rate of reaction. Without wishing to be bound by theory, the inventors suggest that the selenium may poison some sites on the catalyst surface more than others, and the sites which are more poisoned may be those which result in poor selectivity for the dehydrogenation. Using too large an amount of selenium poisons so many sites that the rate of reaction is decreased. Other catalyst poisons that may enhance the selectivity include other electronegative atoms like sulfur or chlorine or other metal-binding Lewis bases like carbon monoxide or cyanide. Other methods for modifying catalyst selectivity include adding electropositive atoms (e.g.,potassium, tin); however, a rate change may be observed with the addition of electropositive atoms.

### Screening of Catalysts for the Hydrogenation Reaction

The magnitude of current that is available from the TRFC is limited by the slowest operation inside the TRFC. That slowest operation could be, for example, hydrogenation at the cathode of the fuel cell, dehydrogenation, proton conduction through the membrane, or pumping of fluid around the system. Since the hydrogenation at the cathode is at a lower temperature than that of the dehydrogenation, it is reasonably likely that the hydrogenation will be rate limiting in a commercial TRFC. Therefore it is important for the hydrogenation to be as fast as possible while maintaining good selectivity. The hydrogenation rate can be increased by: a) changing the catalyst, including using a different metal, a different support, a mixture of metals, and/or adding a promoter to the catalyst; b) changing the structures of X and X^{H}; c) adding a dissolved component into the fluid, such as, for example, a base or a diluent; and/or d) increasing the temperature of the dehydrogenation. Example 11 illustrates that changing the structure of the fluid X can dramatically increase the rate of the hydrogenation. For example, a CF₃ group in the para position of propiophenone greatly increased the rate of hydrogenation relative to unsubstituted propiophenone.

The cathode layer of a membrane electrode assembly of the fuel cell comprises a catalyst (e.g., metal such as Pd, Pt) and a support. In some embodiments, the support is electrically conducting. Example supports include amorphous carbon and vulcanized carbon. A catalyst is required to catalyze hydrogenation of fluid X (e.g. propiophenone) to X^{H} (e.g. 1-phenylpropanol) using either protons from the membrane and electrons from the external circuit or H₂ generated in the cathode, or both. This hydrogenation is preferably fast because in some embodiments it is the rate limiting step in the entire TRFC system and therefore its rate can set the upper limit of current that can be obtained. It also should be very selective for the same reasons discussed earlier; poor selectivity would cause the usable fluid to be slowly converted to inert byproducts, necessitating excessively frequent replacement of the liquid.

For hydrogenation reactions, palladium catalysts have consistently provided better selectivity than platinum catalysts regardless of the support. Pd on SiO₂, Pd on CaCO₃.Pb and Pd on PEI/SiO₂ have given >99.9% selectivity for 1-phenyl-1-propanol from the hydrogenation of propiophenone. Pd on carbon also gives a high selectivity for the desired alcohol (88%).

As discussed above for dehydrogenation catalysts, it is expected that the selectivity and/or the rate of the hydrogenation may be modified by the addition to the catalyst of electronegative atoms, electropositive atoms, or catalyst poisons. Simply using a combination of two or more metals may improve rate and selectivity. It has been shown in the literature that bimetallic catalysts can promote ketone reduction over ring hydrogenation due to enhanced electrostatic interactions of two metal atoms with different electronegativities with a polar C═O bond (M. del, C. Aguirre, P. Reyes, M. Oportus, I. Melian-Cabrera, J. L. G. Fierro, Appl. Catal. A., 2002, 233, 183.). Variations in catalyst reduction temperature, calcination and other pre-treatments may also result in higher selectivities toward the desired unsaturated alcohols.

### Temperature

A high temperature in the dehydrogenation reactor of the planned waste heat conversion system would be maintained by keeping the dehydrogenation reactor close to the engine block of a vehicle or the engine, motor or alternate heat source in a non-vehicular application. Temperatures available near an engine block depend on proximity to the engine block and the presence of potentially-insulating materials between the reactor and the engine block. For the operation of the system, it is necessary that the temperature of the dehydrogenation reactor be significantly higher than the temperature of the fuel cell, so that the equilibrium differs in the two locations as described above. For a fuel cell comprising a Nafion® membrane or membrane of a derivative of Nafion®, a typical operating temperature is about 70 to about 160° C., preferably about 80 to about 105° C. Fuel cells comprising other membrane materials may require operation at other temperatures. For a sufficient difference in the equilibrium between X^{H} and X, a dehydrogenation reactor should be maintained at a substantially higher temperature. A substantial temperature difference for the fuel cell and the dehydrogenation reactor is about 50°, in some embodiments of the invention it is 60°, in other embodiments it is higher than 60°.

Temperatures suitable for the dehydrogenation reactor are about 140 to about 300° C., preferably about 180 to about 250° C. A factor to consider in choosing a temperature for the fuel cell is what type of polymer electrolyte membrane is used between the anode and the cathode. A Nafion® membrane was used for preliminary TRFC studies. Although other membranes have similar operating temperatures, certain membranes require a higher temperature. If such conditions are used, fuel cell temperature may be about 160° C. and the dehydrogenation reactor temp would be at least 50° C. higher than the temperature of the fuel cell.

However, if the temperature of the dehydrogenation reactor is too high, poor selectivity will result in the dehydrogenation reaction. Either a significant portion of the liquid will be irreversibly converted to a non-functioning material, or it will be converted to catalytic or thermal decomposition products like char.

Dehydrogenation experiments described herein were run at 200° C. under a H₂ atmosphere for one hour. If the fuel cell temperature is to be in the range of 130-170° C. then it may be desirable to raise the dehydrogenation temperature above 200° C. in order to maintain a large temperature difference. Therefore, it was necessary to determine if the catalysts being screened could provide selectivity at higher temperatures. At higher temperatures, it may not be practical to use 1-phenyl-1-propanol because its boiling point is only 219° C. Examples of alternative liquids with higher boiling points are 1-phenyl-2-methyl-1-propanol (boiling point: 251° C.) and 1-phenyl-1-pentanol (boiling point: 256° C.). 1-phenyl-2-methyl-1-propanol dehydrogenates to give isobutyrophenone (boiling point: 217° C.). 1-phenyl-1-pentanol dehydrogenates to give valerophenone (boiling point: 245° C.). Since a mixture of liquids of various boiling points will boil at an overall higher temperature than the lowest boiling constituent, it may be practical to use a mixture of X and X^{H} at a temperature that is close to or equal to the boiling point of the lower-boiling of these two compounds. For example, it may be practical to dehydrogenate 1-phenyl-1-pentanol at 245° C. because the reaction will not proceed to completion but rather stop at or before an equilibrium that gives a mixture of ketone and alcohol; therefore the mixture will not boil. Experiments with these fluids at various temperatures are described in Working Example 10.

### Effect of H₂

The effect of an H₂ atmosphere over the liquid in the dehydrogenation reactor was also investigated, because in a working system, it is likely that the gas phase in the reactor would be primarily H₂ with possibly small amounts of organic vapor, air, and/or an inert gas such as N₂. By Le Chatelier's principle, the hydrogen atmosphere that will develop in the reactor should inhibit the dehydrogenation reaction by shifting the equilibrium somewhat towards the hydrogenated material. Therefore, it was also necessary to establish if the dehydrogenation catalysts being screened could afford an acceptable conversion of starting materials (for example >45%) under a H₂ atmosphere in one hour. If dehydrogenation conversion is substantially less than 45% in one hour, then the catalyzed reaction may be too slow to be viable for application in vehicles at that temperature. Also of note, excess H₂ may favor a hydrogenolysis reaction leading to by-product formation.

### Membrane Electrode Assembly

As discussed above, the fuel cell comprises a membrane electrode assembly (MEA). As one skilled in the art will know, a membrane electrode assembly comprises an anode, a cathode, and an electolytic membrane that is interposed between the anode and the cathode, and that is in functional contact with both the anode and the cathode.

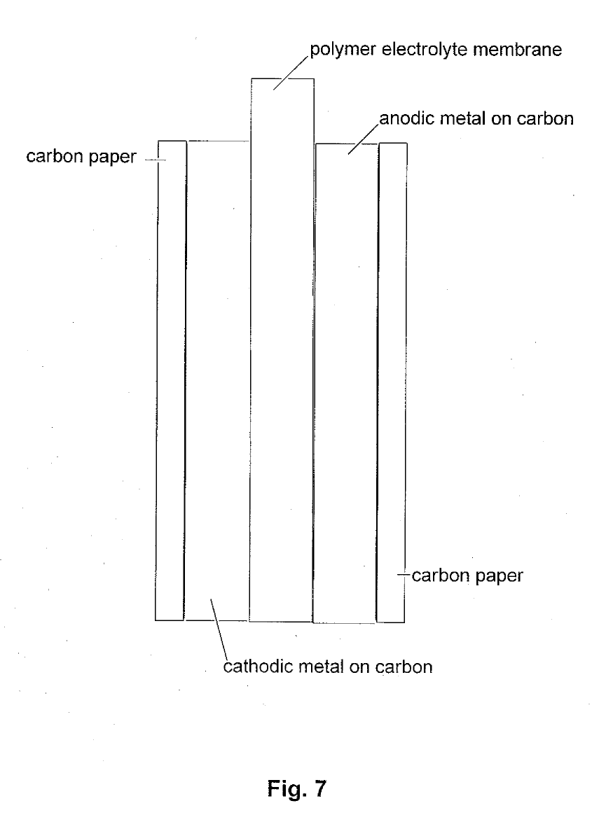

In certain embodiments, an MEA includes five layers sandwiched together (see FIG. 7), where the outermost layers comprise carbon paper. This carbon paper, known as a porous transport layer, facilitates passage of ions from an external liquid and allows the ions to travel from the liquid through to the next layer. On the anodic side, the outermost carbon paper layer is in contact with a layer comprising metal (e.g., Pt or Pd on amorphous carbon). This layer is in contact with a central layer that is a polymer electrolyte membrane (PEM). In turn, the PEM is in contact with a cathodic layer comprising a metal (e.g., Pt or Pd on amorphous carbon), which in turn is in contact with the other outermost carbon paper layer.

### Membrane Selection

Generation of electrical power from waste heat depends on efficient operation of a fuel cell wherein H₂ is catalytically split into protons and electrons at the anode of the cell. The electrons travel through an external circuit to do work and return to the cathode, while the protons migrate from the anode to the cathode through a PEM. The protons and electrons meet fluid rich in X at the cathode, where X is catalytically hydrogenated to a fluid that is rich in X^{H}. Effective operation of the TRFC depends on a PEM that exhibits both high proton conductivity and chemical resistivity.

In a first trial, Nafion® was initially chosen as the PEM for its high proton conductivity, although its chemical compatibility with fluids X^{H} and X were unknown. Membrane swelling studies involved immersing pre-weighed pieces of Nafion® in different ratios of X^{H}, X, and diluents at different temperatures, ranging from 21° C. to 90° C., and for different times, ranging from 1 h to 16 h. These studies revealed incompatibility of Nafion® with various fluid combinations. Typical effects of the fluids on Nafion® include swelling and solvent absorption (30-300% weight gain), pinhole formation, and scarring on the surface of the membrane.

Focus was then placed on preparation and subsequent swelling trials of new PEM candidates. There are many PEM candidates published in the literature and many of them are more compatible with organic solvents and liquids. For example, PEM candidates include sulfonated poly(benzimidazoles) (sPBI) (shown below).

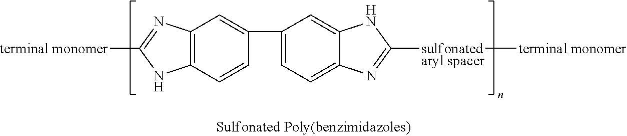

where n is a very large number, terminal monomer refers to the appropriate mono-linked carboxylic or diamino monomers (e.g., in Example 12, the polymer endgroups would be a benzoic acid and a diaminobenzidine), and non-limiting examples of sulfonated aryl spacers include:

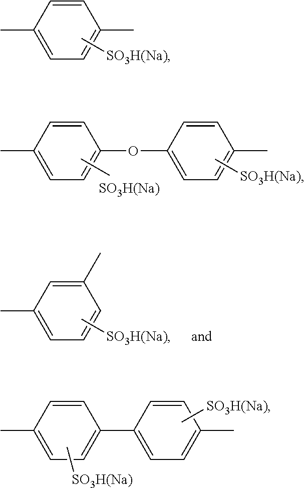

where —SO₃H(Na) indicates that certain —SO₃⁻ moieties have a sodium counterion; however, following soaking in dilute HCl solution, certain —SO₃⁻ moieties are protonated. These polymers exhibit reasonably high proton conductivities at higher temperatures (120° C.-160° C.) compared to Nafion® (96° C.).

Membranes of sPBI were prepared as described in Example 12. Preliminary swelling studies revealed very small or negligible weight gains (0.1-5%) when immersed in different ratios of X^{H} and X at temperatures up to 160° C. In addition, no physical damage to the PEM was observed. Proton conductivity studies and membrane electrode assembly (MEA) construction for online TRFC testing are ongoing.

Referring to FIG. 1, a schematic is shown of a TRFC that uses the reversible dehydrogenation of a liquid X^{H} to form X and H₂.

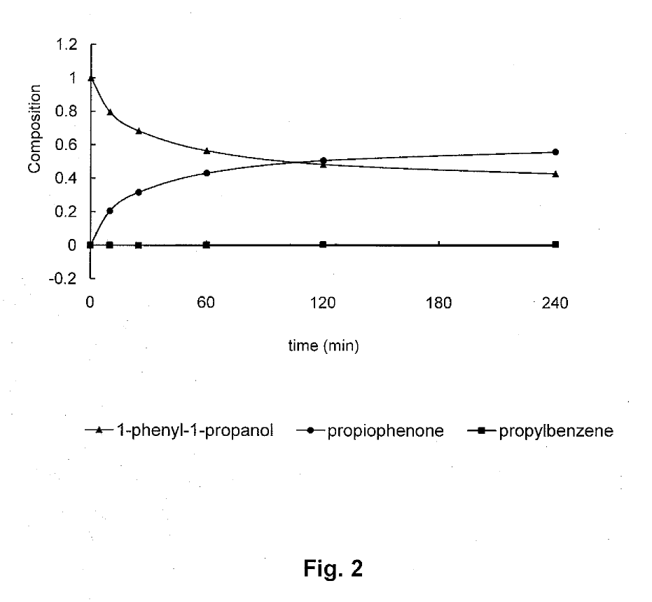

Referring to FIG. 2, a plot is shown of composition versus time for dehydrogenation of 1-phenyl-1-propanol to form propiophenone. Notably, as shown therein, substantially no byproduct propylbenzene was formed.

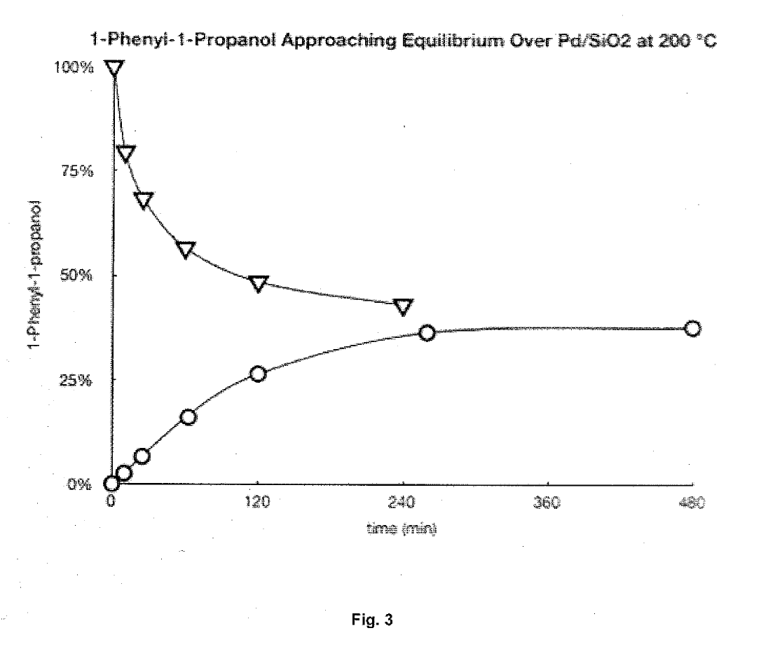

Referring to FIG. 3, a plot is shown of an amount of 1-phenyl-1-propanol versus time for dehydrogenation of 1-phenyl-1-propanol (upper curve) and hydrogenation of propiophenone (lower curve) at 200° C.

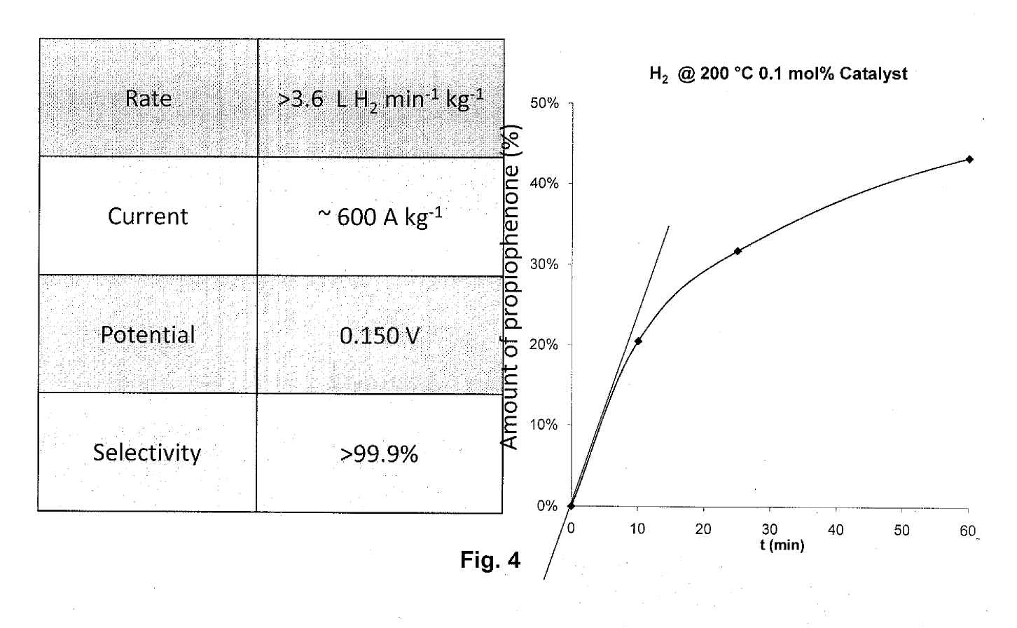

Referring to FIG. 4, a plot is shown and experimental and calculated results are presented. In the plot, experimental results are presented for an amount of propiophenone (%) obtained versus time (min) for the dehydrogenation of 1-phenyl-1-propanol (over 0.1 mol % of 5 wt % Pd on SiO₂ relative to the 1-phenyl-1-propanol) under a H₂ atmosphere. The slope of the initial part of this plot indicated the maximum current achievable from a TRFC using this catalyst/liquid combination, assuming that the dehydrogenation is the rate-limiting step in the TRFC system. The slope is related to the rate of H₂ generation, which was found to be 3.6 litres of H₂ per minute per kilogram of 1-phenyl-1-propanol that would be achievable for such a TRFC. This rate was then converted to a current that would be achievable from this system. Specifics in regard to this calculation will now be described. For a batch process wherein 1-phenyl-1-propanol is heated to 200° C. in the presence of 0.1 mol % equivalent Pd in the form of 5 wt % Pd on silica under an atmosphere of hydrogen gas, the average rate of hydrogen evolution over the first ten minutes of reaction time is 206.7 millimoles of hydrogen per gram of palladium per minute. Since every mole of hydrogen evolved dissociates into two electrons at the anode of the fuel cell the maximum rate of electron generation is therefore 413.5 millimoles of electrons per gram of palladium per minute. Alternatively, this can be stated 6.9 millimoles of electrons per gram of palladium per second. So the maximum current for 1 kg of 1-phenyl-1-propanol would be 664.9 amperes per gram of palladium.

Also indicated in FIG. 4 is a potential of 0.150 volts. This data was obtained from a multimeter that was connected to a fuel cell (obtained at Fuel Cell Store, Inc. San Diego, Calif., USA) having a Nafion® electrolyte membrane, which in turn was in liquid and gaseous connection with a dehydrogenation reactor, with the liquid from the dehydrogenation reactor passing to the fuel cell's cathode and the gas from the dehydrogenation reactor passing to the fuel cell's anode. The dehydrogenation reactor was loaded with this catalyst/liquid combination. FIG. 4 also recites the selectivity level (>99.9%) that was obtained for the reaction described by the plot. If, however, hydrogenation at the cathode or the electron flow through the membrane is rate limiting, then maximum achievable current will be lower.

Referring to FIG. 5, kinetics of dehydrogenation of benzylic alcohols that were reacted at 200° C. over 0.1 mol % Pd/SiO₂ are presented. Specifically, a plot is shown of an amount of conversion to unsaturated product versus time for three benzylic alcohols. The lowest rate was observed for benzyl alcohol, followed by 1-phenyl-1-propanol, and the best rate observed was for 1-phenyl-1-ethanol.

Referring to FIG. 6, a plot is shown of log (k_{X}/k_{H}) versus σₚ, where log (k_{X}/k_{H}) means logarithm of the ratio of the rate constant for hydrogenation of a para-substituted propiophenone to the rate constant for hydrogenation of propiophenone, and where σₚ is para Hammett sigma parameter (i.e., for the para substituent). This plot shows that the rate constant (and therefore the rate) is greater if the para substituent is electron withdrawing (i.e., has a large para Hammett sigma parameter).

Referring to FIG. 7, an embodiment of a Membrane Electrode Assembly is shown.

Referring to Table 1, structures of certain dehydrogenatable/hydrogenatable compounds are shown.

Referring to Table 2, experimental results are presented for dehydrogenation/hydrogenation studies conducted for the catalyst/liquids wherein the preferred level of selectivity was obtained.

Referring to Table 3, experimental results are presented for dehydrogenation/hydrogenation studies conducted in the search for compounds exhibiting the preferred selectivity levels. Catalyst/liquid combinations in Table 3 have been rejected from further study due to their poor performance in either dehydrogenation or hydrogenation reactions. In some cases, one of the reaction directions was sufficiently selective, but the reverse reaction was insufficiently selective. In certain cases, dehydrogenation in the absence of H₂ gas was sufficiently efficient, but when dehydrogenation in the presence of H₂ gas was tested, the results were less promising.

Referring to Table 4, experimental results are presented for dehydrogenation studies of 1-phenyl-1-propanol (see Example 9).

Referring to Table 5, experimental results are presented for specified catalysts on supports in dehydrogenation of 1-phenyl-1-pentanol at 245° C. Referring to Table 6, experimental results are presented for specified catalysts on supports in dehydrogenation of 1-phenyl-1-pentanol at 230° C. Referring to Table 7 experimental results are presented for specified catalysts in dehydrogenation of 1-phenyl-2-methyl-1-pentanol at 220° C. Notably, higher temperature resulted in higher conversions but poorer selectivities.

Referring to Table 8, experimental results are presented for hydrogenation of para-substituted propiophenones at 100° C. for 1 h under 1 atm of H₂ over 1 mol % Pd on SiO₂. Notably, the selectivity is higher than the selectivity of the dehydrogenation.

In conclusion, in the studies described herein, a dehydrogenation catalyst has been established that provides the preferred selectivity in combination with compounds of formula (1). It is 5% Pd on SiO₂. In studies described herein, this catalyst in combination with non-limiting examples of compounds of formula (1) was shown to provide excellent selectivity and conversion. These representative examples show that the certain combinations of liquids and catalyst offer extremely high selectivity, and have application in the TRFC industry.

It will be understood by those skilled in the art that this description is made with reference to certain preferred embodiments and that it is possible to make other embodiments employing the principles of the invention which fall within its spirit and scope as defined by the claims.

### WORKING EXAMPLES

The following chemicals were obtained from Sigma-Aldrich (Oakville, Ontario, Canada) and used as received: Benzyl alcohol (≧99%); α-methylbenzyl alcohol (99+%); decyl alcohol (99%); ethylene glycol (≧99%); 1,2-propanediol (99%); 2,3-butanediol (98%); 1,3-propanediol (98%); 1,3-butanediol (99%); 2,4-pentanediol (98%) (mixture of isomers); 1-methylindole (≧97%); 2,3-benzofuran (99%); 2,3-dihydrobenzofuran (99%); ethylene carbonate (98%); 2-imidazolidone (96%); diethyl succinate (99%); succinic anhydride (99+%); succinimide; bibenzyl (99%); benzylamine (99.5%); N-phenylbenzylamine (99+%); DL-α-methylbenzylamine (99%); ethyl (S)-(−)-lactate (98%); aniline (99%); acetophenone (99%); propiophenone (99%); propylbenzene (98%); hexadecane (99%); nickel ˜60 wt % on kieselghur; ruthenium; 5 wt % on alumina, powder, Degussa type H213; chloroform-d (99.8 atom % D); deuterium oxide (99.9 atom % D); 4,4′-oxybis(benzoic acid) (99%); 3,3′-diaminobenzidine; methanesulfonic acid (99.5%); phosphorus pentoxide (97%); sulfuric acid (95%); and dimethyl sulfoxide (99.69%).

1-Phenyl-1-propanol (99%) was obtained from Acros Organics (Geel, Belgium) and was used as received. α-Methylbenzylaniline was prepared by reductive amination of acetophenone with aniline. Hydrogen (99.999%); helium (99.999%); nitrogen (99.999%); argon (99.999%); and air (extra dry) were obtained from Praxair (Mississauga, Ontario, Canada). The following chemicals were obtained from Alfa Aesar (Ward Hill, Mass., USA) and used as received: 1% platinum on ⅛″ alumina pellets (reduced); 10% platinum on alumina powder (reduced); 10% platinum on carbon (reduced); 50% platinum 25% ruthenium on high surface carbon; 90% platinum 10% iridium gauze (150 mesh); 2-methyl-1-phenyl-1-propanol (98%); and 1-cyclohexyl-1-propanol (97%).

The following chemicals were obtained from Strem Chemicals (Newburyport, Mass., USA) and used as received: 5% Platinum on silica powder (reduced, dry); 5% platinum on calcium carbonate (unreduced, dry); 5% palladium on alumina (reduced); 5% palladium on barium carbonate (reduced); 5% palladium on barium sulfate (reduced); 5% palladium on calcium carbonate 1.6% Pb (poisoned, reduced, dry); 5% palladium on calcium carbonate (unpoisoned, reduced); 5% palladium on silica powder (reduced, dry); 1% palladium on polyethylenimine/SiO₂ (20-40 mesh beads); 3% palladium on polyethylenimine/SiO₂ (40-200 mesh powder); 0.5% rhodium on ⅛″ alumina pellets; 5% rhodium on alumina powder; 5% rhodium on carbon powder; 0.5% ruthenium on ⅛″ alumina pellets; 5% ruthenium on alumina; and 5% ruthenium on carbon. 1-phenyl-pentanol (98+%) and butyroin (96+%) were obtained from TCI America (Portland, Oreg., USA) and used as received.

Potassium hydroxide pellets; hydrochloric acid (37%); and sodium bicarbonate (99.5%) were obtained from Fisher Scientific (Ottawa, Ontario, Canada).

Heating and/or stirring of reactions was performed using either a VWR Signature™ 800 Series Digital Hot Plate Stirrer available from VWR International (Mississauga, Ontario, Canada) or a Thermo Scientific Super-Nuova Digital Top Stirring Hot Plate model SP131825 available from Fisher Scientific Limited (Nepean, Ontario, Canada). A thermocouple probe was immersed in a hot oil bath formed from a 150×75 mm crystallization dish filled with silicone oil, available from Fisher Scientific (Ottawa, Ontario, Canada). Screening of substrates was performed using a Carousel 12 Place Reaction Station™ (RR98030) manufactured by Radleys Discovery Technologies (Essex, United Kingdom). ¹H NMR spectra were collected at 300 K on a Bruker AV-400 spectrometer at 400.3 MHz. Gas chromatography was performed using a Shimadzu GC-17A available from Shimadzu Scientific Instruments (Columbia, Md., USA) equipped with an Agilent J&W Ultra Inert GC column with a DB-5ms stationary phase (inner diameter 0.25 mm, length 30 m, film thickness 0.25 μm) from Agilent Technologies (Santa Clara, Calif., USA). Catalyst surface areas and pore size were determined using a Micromeritics Accelerated Surface Area and Porosimetry System 2010 manufactured by Micromeritics Instrument Corporation (Norcross, Ga., USA).

For polymerization reactions, the following equipment were obtained from Fisher Scientific (Ottawa, Ontario, Canada): overhead stirring was performed with a IKA® Eurostar Power Control-Visc overhead stirrer; a 500 mL Pyrex® kettle flask was used as the reaction vessel. Heating was performed with a hemispherical mantle connected to a Staco Energy Products Co. (Dayton, Ohio, USA) Variable Autotransformer. Other heating and/or stirring was performed using a Thermo Scientific Super-Nuova Top Stirring Hot Plate model SP131825 from Fisher Scientific (Ottawa, Ontario, Canada). Drying of polymer solids and films was achieved using a Fisher Scientific Isotemp® Vacuum Oven model 281, from Fisher Scientific (Ottawa, Ontario, Canada) attached to a PIAB Lab Vac model H40 from Sigma-Aldrich (Oakville, Ontario, Canada).

### Example 1

### Studies Regarding Rate of Dehydrogenation

1-Phenyl-1-propanol, a liquid, (5 mL, 4.97 g, 36.5 mmol) was dispensed into a 25 mL pear shaped two-necked reaction flask with 14/20 standard taper ground glass joints. To this was added palladium, 5% on silica powder, (reduced, dry Escat™ 1351 available from Strem Chemicals, Inc., Newburyport, Mass., USA) (77.7 mg, 3.9 mg Pd, 9.2 μmol) and a Teflon™ coated magnetic stirring bar. One neck of the flask was fitted with a cold water condenser and the flask was sealed by placing rubber septa in the second neck and at the top of the condenser. A gas bubbler containing silicone oil was connected to the top of the condenser using plastic tubing using a Luer-Lock-to-hose barb adaptor and a 20 gauge 1.5″ long disposable needle which penetrated the septum. A hydrogen cylinder was fitted with a single stage regulator and attached to the reaction flask through its septa using plastic tubing and 6″ needle whose tip was allowed to rest at the bottom of the flask so gas would bubble through the liquid layer. The apparatus was clamped above a magnetic stirring hot plate equipped with a thermocouple probe. On the hot plate was placed a crystallization dish filled with silicone oil into which the thermocouple probe was placed. The apparatus was suspended above the level of the oil bath and the hot plate was set to heat and maintain the oil bath to a temperature of 200° C. The stir rate was set to 400 rpm. The hydrogen source was opened and the apparatus was purged with approximately 10 mL of hydrogen gas per minute at atmospheric pressure for an hour while the oil bath reached thermal equilibrium. At this point the apparatus was submerged in the oil bath so the liquid level in the flask was at the same level as that in the oil bath and a timer was started while maintaining hydrogen flow through the apparatus. 50 μL aliquots of the reaction mixture were removed at regular intervals (10, 30, 60, 120, 240 and 480 minutes) using a 6″ needle and a disposable 1 mL syringe. Each aliquot was diluted by 0.5 mL of chloroform-d and filtered through a small KIMWIPE™ tissue plug in a pasteur pipette into an NMR tube. A KIMWIPE™ is a lint-free cleaning tissue; when a small amount of a KIMWIPE™ is forced into the end of a disposable pipette, it forms a filter for separating solids from small volume reaction mixtures. The ¹H-NMR spectrum of each aliquot was recorded and analyzed to determine the relative amounts of 1-phenyl-1-propanol and propiophenone as a function of time (see FIG. 2).

### Example 2

### Studies Regarding Rate of Hydrogenation

This reaction was performed in a similar fashion to that outlined in Example 1 with the following changes: unsaturated compound propiophenone was used in place of 1-phenyl-1-propanol and the oil bath was heated and maintained at 100° C. instead of 200° C.

### Example 3

### Determination of the Equilibrium Composition of a Liquid Mixture at a Given Temperature

To determine the equilibrium composition of a liquid at a given temperature two reactions were performed in tandem using the apparatus described in Example 1. One apparatus was loaded with 1-phenyl-1-propanol and the other was loaded with propiophenone. Both reactions were sampled periodically as outlined in Example 1 and the equilibrium composition was reached when the composition of both apparatuses are identical and no longer change with time (see FIG. 3). It was determined that at 200° C., a mixture at equilibrium was approximately 39% 1-phenyl-1-propanol and approximately 61% propiophenone.

### Example 4

### Screening Liquids for Reactivity

Three candidate saturated liquids (X), (N-methylindole; 2,3-benzofuran; and propiophenone) were tested for their ability to be selectively and rapidly hydrogenated. Reactions were performed by mixing 5 mL of the respective liquid with 0.1 mol % equivalent of Pd. Pd was in the form of palladium on activated carbon, 10 wt %, reduced. Reactions were conducted in 25 mL pear shaped flasks equipped with a reflux condenser, a magnetic stir bar that were sealed with a rubber septum. H₂ was bubbled through each mixture at a rate of 10 mL/min. Mixtures were simultaneously stirred and heated for a period of six hours in an oil bath that was maintained at 100° C. Samples of resultant reaction mixtures were diluted in chloroform-d and filtered through a KIMWIPE™ tissue plug in a pipette. Filtrates were analyzed by ¹H NMR spectroscopy (see Tables 2 and 3). Since only a small amount of product was detected from hydrogenation of N-methylindole relative to side-products, conversion and selectivity of that reaction could not be determined by ¹H NMR spectrometry. Because the N-methylindole was not hydrogenated completely or selectively, it was not investigated further.

The hydrogenated forms X^{H} of the two remaining liquids (2,3-benzofuran; and propiophenone) were tested for their ability to be dehydrogenated selectively at 200° C. Reactions were performed by mixing 5 mL of an organic substrate with 0.1 mol % equivalent of Pd. The Pd was in the form of palladium on activated carbon, 10 wt %, reduced. Reactions were conducted in 25 mL pear shaped flasks each equipped with a reflux condenser and a magnetic stir bar and that were sealed with a rubber septum. Argon gas at 1 atm was bubbled through the mixtures at a rate of 10 mL/min. Reaction flasks were stirred and heated for a period of six hours in an oil bath held at 200° C. Samples of resultant mixtures were diluted in chloroform-d and filtered through a KIMWIPE™ tissue plug in a pasteur pipette and filtrates were analyzed by ¹H NMR spectroscopy (see Tables 2 and 3).

We rejected 2,3-benzofuran as a candidate liquid (X) because of the poor selectivity of the dehydrogenation of the hydrogenated form (2,3-dihydrobenzofuran).

### Example 5

### Initial Screening of Catalysts for the Dehydrogenation of 1-phenyl-1-propanol

Experiments were conducted to determine whether the presence of H₂ would effect dehydrogenation of 1-phenyl-1-propanol and specifically whether the dehydrogenation would still take place selectively in the presence of H₂ gas.

Reactions were performed by mixing 5 mL of 1-phenyl-1-propanol with 0.1 mol % equivalent of Pd catalyst. Three kinds of Pd catalysts were tried separately, each in a 25 mL pear shaped flask equipped with a reflux condenser and a magnetic stir bar. The flasks were sealed with a rubber septum. H₂ gas at 1 atm was bubbled through the mixtures at a rate of 10 mL/min and were stirred and heated in an oil bath at 200° C. for 4 h. Samples were diluted in chloroform-d and filtered through a KIMWIPE™ tissue plug in a pasteur pipette and filtrates were analyzed by ¹H NMR spectroscopy.

It was found that dehydrogenation was selective for Pd on silica catalyst. Extensive hydrogenolysis to propylbenzene occurred for other tested catalysts.

For more precise selectivity values, similar experiments were characterized using gas chromatographic analysis rather than NMR spectroscopy. Reactions were performed by mixing 1 mL of 1-phenyl-1-propanol with 0.1 mol % equivalent of catalytic metal in a 16×150 mm test tube containing a magnetic stir bar sealed with a rubber septum. H₂ was bubbled through the mixtures at a rate of 10 mL/min and they were heated with stirring in an oil bath held at 200° C. for a period of one hour. The samples were spiked with a known amount of a hexadecane external standard, diluted in acetone and filtered through a KIMWIPE™. Filtrates were analyzed by gas chromatography (see Tables 2 and 3). Product mixture from an experiment involving Pt/C had a large unidentified side-product peak which co-eluted with the expected product. The experiment with Ni/kieselguhr was run at 1 mol % catalyst loading. Greatest selectivity was obtained for Pd on silica, where the selectivity for propiophenone was 99.85%.

### Example 6

### Further Screening of Liquids for Reactivity

A Carousel 12 Place Reaction Station™ (Radley Discovery Technologies, Essex, UK) was used to rapidly screen potential liquids by testing their ability to dehydrogenate using the following method. To each of twelve reaction tubes was added a Teflon™ coated magnetic stirring bar, approximately 1 g of a saturated liquid (only 250 mg in the case of α-methylbenzylaniline) and an amount of supported catalytic metal. The total metal loading was 0.1 mol % equivalent with respect to the saturated liquid. For example, 1 g of benzyl alcohol was weighed into two different reactor tubes. To one of these (19.7 mg, 1 mg Pd, 9.2 μmol) of palladium, 5% on silica powder, reduced, dry (Escat™ 1351) (Strem Chemicals, Inc., Newburyport, Mass., USA) was added and to the other (18.7 mg, 1 mg Ru, 9.2 μmol) of ruthenium, 5% on alumina powder, (Degussa type H213) (Sigma-Aldrich Canada Ltd., Oakville, Ontario, Canada) was added. The reaction tubes were capped with a screw-on cap that is part of the carousel reactor system and was installed in a carousel reactor. Each cap has a hole where a septa can be fitted to seal it after an initial flushing with hydrogen as described below. All twelve positions of the carousel reactor were filled and each reaction tube was fitted to the central gas manifold which was attached to a hydrogen cylinder using plastic tubing. The water inlet and outlet of the carousel reactor were attached to a municipal water supply and drained respectively using the tubing. The flow of water through the carousel's cooling unit was initiated and the flow of hydrogen gas through each of the attached reaction tubes was started allowing each to be flushed with hydrogen gas and expelling the air contained within at a rapid rate of approximately 50 mL of hydrogen per minute, for ten minutes. The flow of hydrogen was then lowered to approximately 10 mL per minute and all of the tubes' caps were sealed with septa. One of the tubes was attached to a gas bubbler filled with silicone oil using plastic tubing and a Luer-Lock to hose barb adaptor and a 20 gauge 1.5″ long disposable needle. The stir rate of the carousel reactor was set to 300 rpm and the heater was set to 200° C. After the reactor reached 200° C. the reaction was allowed to proceed for one hour. At this point, the flow of hydrogen gas was stopped and all the tubes were closed off from the hydrogen supply and removed from the carousel reactor and cooled. The reaction mixtures were then suspended in either 1 mL of deuterated chloroform or deuterium oxide and were either filtered through a small tissue plug in a pasteur pipette (for chloroform solutions) or were allowed to settle in a glass vial for one day before being decanted into a clean vial (for viscous aqueous samples). The ¹H-NMR spectrum of each sample was recorded and was analyzed to determine the conversion and selectivity of the dehydrogenation reaction (see Tables 2 and 3).

### Example 7

### Screening Catalysts for Activity and Selectivity

Catalytic selectivity in dehydrogenation of benzylic alcohol 1-phenyl-1-propanol was investigated to identify a catalyst that provides the highest possible selectivity for the dehydrogenated product of 1-phenyl-1-propanol, propiophenone (see Table 1). All catalysts investigated during this study are listed in Tables 2 and 3.

Each reaction was performed in duplicate, using the same oil bath. Prior to the start each reaction, the oil bath was given no less than one hour to stabilize at the required temperature. Reactions were run in a 16×150 mm test tube, into which was placed a magnetic stir bar, the appropriate catalyst at 0.1 mol % loading relative to the alcohol, and 1 mL of 1-phenyl-propanol. The test tube was then fitted with a 19 gauge rubber septum. To maintain the reaction under an atmosphere of H₂, the H₂ gas was introduced to the test tubes through a 4-port gas manifold fitted with Fisherbrand tubing, a 3 mL syringe barrel (without plunger) and 25 gauge needle tip. The needle was inserted through the septum so H₂ could flow into the test tube. A bubbler was attached to the end of the gas manifold to allow for the gaseous phase to be continuously vented, allowing a low dynamic flow of H₂ to be maintained throughout the reaction's duration. Each test tube was purged with a high flow of H₂ for 5 minutes to replace the air atmosphere within the test tubes prior to exposure to heat.

After 5 minutes of atmospheric purging, each test tube was lowered into the oil bath at a depth no greater than the height of liquid in the test tube and was stirred using a stir plate which was underneath the oil bath. Each reaction was then run for one hour at 200° C. under a low dynamic flow of H₂ with constant stirring. After the one hour, each test tube was removed from the oil bath, the H₂ atmosphere was vented through the gas manifold bubbler and each test tube was placed in ice to quench the reaction. Once the reaction mixture was cooled to 0° C., the catalyst was separated from the organic liquid by filtering the mixture through a glass disposable pipette fitted with a KIMWIPE™ plug.

A ¹H NMR spectrum of the organic liquid was acquired on a Bruker AV-400 NMR spectrometer at 400.3 MHz using chloroform-d as solvent for each catalytic run. Through normalization and subsequent comparison of the integral values for the 1-phenyl-1-propanol benzylic proton, the propiophenone methyl protons, and the propylbenzene benzylic methylene protons, the percent conversion of the starting material and percent selectivities for each product was calculated. The results are presented in Tables 2 and 3. A tertiary by-product was observed for some of the non-viable catalysts. Subsequently, the percent selectivities were approximated using the same proton signal (quartet, 2.4 ppm) that was attributed to this tertiary product. Any heterogeneous catalysts that failed to provide a selectivity of 99% for the product propiophenone was eliminated as a viable candidate. The heterogeneous catalysts that did provide the required selectivity were analyzed for surface area and pore size using a Micromeritics Accelerated Surface Area and Porosimetry System (Micromeritics Instrument Corporation, Norcross, Ga., USA).

### Example 8

### Synthesis of Pd on SiO₂

A pellet version of palladium on silica was prepared by an impregnation method. Pellets of amorphous silica (3 mm) were obtained from Saint-Gobain NorPro (Stow, Ohio, USA). Silica pellets (5 g) were added to a solution of 25 mL of 2-propanol and 530 mg of palladium (II) acetate (available from Pressure Chemical Co., Pittsburgh, Pa., USA). The mixture was stirred overnight and the mixture was filtered. Some palladium (II) acetate remained in solution so the exact amount of palladium absorbed onto the resultant impregnated silica was unknown but was less than 5 wt %. Impregnated pellets were dried in a 120° C. for 12 hours and then heated to 200° C. in a H₂ atmosphere for four hours. A final product was a pelleted form of palladium metal supported on amorphous silica.

Since the amount of palladium on the silica pellets was less than 5 wt % dehydrogenation of 1-phenyl-1-propanol was performed using this catalyst at a palladium loading of less than 0.1 mol % palladium with respect to 1-phenyl-1-propanol. Reaction product showed less conversion in the same amount of time (30% conversion after one hour) when compared with the commercial palladium on silica (Escat™ 1351 as described above), which exhibited 49% conversion after one hour; but retained the same selectivity as the commercial catalyst (≧99%).

### Example 9

### Effect of Se on Conversion and Selectivity for the Dehydrogenation of 1-phenyl-1-propanol Over sol-gel Pd on SiO₂ Catalyst

To determine whether selenium in a Pd/SiO₂ catalyst could improve the selectivity of dehydrogenation of 1-phenyl-1-propanol, a series of Pd/SiO₂ catalysts were made by a sol-gel method with varying amounts of selenium content. As shown in Table 4, it is clear from the results that a small amount of selenium improves the selectivity considerable without significantly slowing down the catalyst.

### Example 9A

### Catalyst Synthesis

Synthesis of the sol-gel catalysts was based on a literature procedure (T. Lopez, et al. J. Catal., 1992, 133, 247-259). Reagent ratios were used from the Lopez et at synthesis as basis for amount of reagents used in these syntheses: mmol support precursor/mL solvent, mol base/mol support precursor and mol H₂O/mol support precursor. The amount of metal precursor used was based on the desired weight percent loading of the metal on the combined final weight of the support and selenium. Weight percent of selenium was calculated based on final weight of support only.

Preparation of 5 wt % Palladium with 5 wt % Se on SiO₂ was performed as follows. Tetraethoxy orthosilicate (support precursor, 21.5 mmol, 4.80 ml), anhydrous ethanol (solvent, 2.0 ml), palladium(II) chloride (metal precursor, 0.7122 mmol, 126.3 mg), selenium tetrachloride (selenium precursor, 1.418 mmol, 313.0 mg) and 30% aqueous ammonium hydroxide (base, 0.3 ml) were combined in a 15-ml round bottom flask equipped with a magnetic stir bar and a water-cooled condenser under air. The round bottom flask was submerged in an 80° C. oil bath, under which was a magnetic stir plate. The mixture was stirred magnetically at 300 rpm for 10 min under argon flowing in via one of two needle located in a septum at the top of the water-cooled condenser and then out through the second of the two needles. The lower ends of both needles were in the gas phase inside the condenser. Water (2.0 mL) was then injected directly into the reaction mixture through the septum at the top of the condenser using a syringe equipped with a 30 cm needle. The mixture was then stirred for an additional 4 h, during which time gel formation took place. The reaction flask was cooled by removing it from the oil bath, then the reaction mixture was filtered by vacuum filtration using a Büchner funnel, dried under dynamic vacuum for 18 h in a vacuum desiccator, then further dried in an oven at 400° C. under air for 4 h. The amount of selenium tetrachloride used was altered (along with the amount of metal precursor to maintain 5 wt % metal/support ratio) in order to produce the other catalysts, including one with no selenium content.

### Example 9B

### Catalyst Screening Experiments

The catalyst being tested (0.1 mol % Pd based on amount of 1-phenyl-1-propanol used, 0.073 mmol, 15.5 mg) was weighed and transferred into a 16 x 150 mm test tube. 1-phenyl-1-propanol (7.3 mmol, 1.0 ml) was added to the test tube via a needle and syringe. A small, magnetic stir bar was added and the test tube was capped with a rubber septum. The mixture was stirred magnetically at 300 rpm by a stir plate below, and the headspace flushed with hydrogen gas delivered through a long needle injected through the septum, positioned just above the liquid level, for 15 min. Gas was allowed to escape through a second needle through the septum. At this time, the outlet needle was removed, and the gas manifold line was opened to an external oil bubbler to maintain a hydrogen pressure in the vessel of approximately 1 atm. The test tube was then submerged in an oil bath held at 200° C. so that the liquid in the tube was just below the oil level and left while continuing to be stirred magnetically. After 1 h, the test tube was removed from the oil bath and placed directly into an ice bath to stop the reaction, while the line delivering hydrogen was also removed. A small aliquot of the reaction mixture was then removed and added to 1 ml deuterated chloroform. The chloroform-containing mixture was then passed through a 5″ glass pipette plugged with a lint-free tissue wipe under Celite 545® into an NMR tube for NMR spectroscopic analysis. Conversions and selectivities were then calculated using ¹H NMR spectroscopy collected at 300 K on a Bruker AV-400 spectrometer operating at 400.3 MHz and referenced to SiMe₄.

### Example 10

### Dehydrogenation at Temperatures Above 200° C.

Initially, dehydrogenation studies were conducted for 1-phenyl-1-pentanol at a temperature of 245° C. 1-phenyl-1-pentanol was chosen for this investigation due to the high boiling points of it and its potential products. The catalysts selected for this investigation were the five catalysts that afforded selectivities of ≧99.9% for propiophenone at 200° C., as identified in the aforementioned catalyst screening: 5% Pd on CaCO₃.Pb; 5% Pd on BaCO₃; 5% Pt on SiO₂; 5% Pd on SiO₂; and 1% Pd on polyethylimine.SiO₂ ROYER. Results are outlined in Table 5.

Two catalysts, 5% Pd on CaCO₃.Pb and 1% Pd on polyethylimine.SiO₂ ROYER, afforded selectivities of 99% for valerophenone at 245° C. Accordingly, both catalysts were chosen for additional testing at a lower temperature of 230° C.; selectivity improved from 99% to 99.9% for catalyst 1% Pd on polyethylimine.SiO₂ ROYER. Results are outlined in Table 5.

Based on their high boiling points and results that were obtained for 1-phenyl-1-propanol and its ketone, it was decided to test 1-phenyl-2-methyl-1-propanol and its ketone since these were also expected to have high boiling points. 1-phenyl-2-methyl-1-propanol was tested as a potential high temperature liquid at 220° C. with 1% Pd on polyethylimine.SiO₂ ROYER. Results are outlined in Table 6. A detailed method for these experiments was as follows:

Each reaction was performed in duplicate, using the same oil bath. Prior to the start each reaction, the oil bath was given no less than one hour to stabilize at the required temperature. Reactions were run in 25×150 mm test tubes. Into each test tube was placed: a magnetic stir bar, appropriate catalyst at 0.1 mol % loading relative to alcohol, and 1 mL of alcohols 1-phenyl-1-pentanol or 1-phenyl-2-methyl-1-propanol, respectively. The test tube was then sealed with a rubber septum. To maintain the reaction under an atmosphere of H₂, H₂ gas was introduced to the test tubes through a gas manifold with tubing and a needle. The needle was inserted through the septum so H₂ could flow into the test tube and the tip of the needle was positioned just above the top of the liquid to facilitate maximum air displacement. A syringe needle tip was also inserted through the septum to act as a vent, allowing any volume of air within the test tube to be displaced. Each test tube was purged with a high flow of H₂ for 15-20 minutes to replace the air atmosphere within the test tubes prior to exposure to heat. A bubbler was attached to the end of the gas manifold to prevent a build up of pressure, and so that H₂ pressure could be maintained throughout each reaction.

After 15-20 minutes of purging, the vent needle was removed and the inflow needle was repositioned such that the tip was at the top of the test tube, just below the end of the septum. Each test tube was then lowered into the oil bath at a depth no greater than the height of liquid in the test tube and was stirred using a stir plate which was underneath the oil bath. Each reaction was then run for one hour at 220° C. (1-phenyl-2-methyl-1-propanol) or 230° C. or 245° C. (1-phenyl-1-pentanol) under a low dynamic flow of H₂ (through the bubbler) with constant stirring. After one hour, each test tube was removed from the oil bath, the H₂ atmosphere was vented through the gas manifold bubbler and each reaction mixture's test tube was placed in ice to quench the reaction. Once the reaction mixture was cooled to 0° C., the catalyst was separated from the liquid by filtering the reaction mixture through a glass disposable pipette fitted with a KIMWIPE™ plug. (A KIMWIPE™ is a lint-free cleaning tissue; when a small amount of a KIMWIPE™ is forced into the end of a disposable pipette, it forms a filter for separating solids from small volume reaction mixtures.)

A ¹H NMR spectrum of the organic liquid was acquired on a Bruker AV-400 NMR spectrometer at 400.3 MHz using chloroform-d as solvent for each catalytic run. Through normalization and subsequent comparison of the integral values for the following, the percent conversion of the starting material and percent selectivities for each product were calculated. Thus respective values were obtained for the following: benzylic protons of 1-phenyl-2-methyl-1-propanol and 1-phenyl-1-pentanol, α-methylene protons of the respective ketone products, α-methylene ring protons of the hydrogenolysis products, methyl ring protons of the hydrogenated keto side product for 1-phenyl-2-methyl-1-propanol, α-methylene ring protons of the hydrogenated keto side product for 1-phenyl-1-pentanol. Results are presented in Tables 5-7.

### Example 11

### Hydrogenation of Propiophenone and its Derivatives

Propiophenone (para substituent=H)

Palladium, 5 wt % on silica (1 mol % palladium loading based on amount of propiophenone used, 0.075 mmol Pd, 159.6 mg catalyst) was weighed and transferred into a 16×150 mm test tube. Propiophenone (7.5 mmol, 1.0 ml) was added to the test tube via a needle and syringe to form a mixture. A small, magnetic stir bar was added and the test tube was capped with a rubber septum. The mixture was stirred magnetically at 300 rpm, and for 15 min the test tube's headspace was flushed with hydrogen gas delivered through a 20 cm needle inserted through the septum and positioned just above the liquid level. Gas was allowed to escape through a second needle inserted through the septum. At this time, the outlet needle was removed, the inlet needle was withdrawn to just below the septum, and the gas manifold line was opened to an external oil bubbler to maintain a hydrogen pressure in the vessel of approximately 1 atm. The test tube was submerged in an oil bath held at 100° C. so that the liquid in the tube was just below the oil level, and was continuously stirred magnetically. After 1 h, the test tube was removed from the oil bath and placed directly into an ice bath to stop the reaction, while the line delivering hydrogen was also removed. A small aliquot of the reaction mixture was then removed into ˜1 mL deuterated chloroform, then this mixture was passed through a 5″ glass pipette plugged with a lint-free tissue wipe under Celite 545® and collected in an NMR tube for NMR spectroscopic analysis. Conversions and selectivities were then calculated using ¹H NMR spectroscopy collected at 300 K on a Bruker AV-400 spectrometer operating at 400.3 MHz and referenced to SiMe₄.

Substituted Propiophenones (para Substituent=Me, OMe, CF₃)

The above procedure was followed exactly with 1.0 mL (or 0.5 g for 4′-trifluoromethylpropiophenone) of the substituted propiophenone, and an appropriate amount of palladium, 5 wt % on silica to give 1 mol % palladium loading based on the propiophenone.

Results of these studies are presented in Table 7.

### Example 12

### Preparation of Sulfonated Polybenzimidazoles for Use as a Polymer Electrolyte Membrane in the Thermally Regenerative Fuel Cell

Below is a typical synthetic scheme for polybenzimidazoles described herein. It is a modified literature procedure (Ueda, M. et al. Macromolecules 1985, 18, 2723-2726, Xu, H. et al. Polymer 2007, 48, 5556-5564).

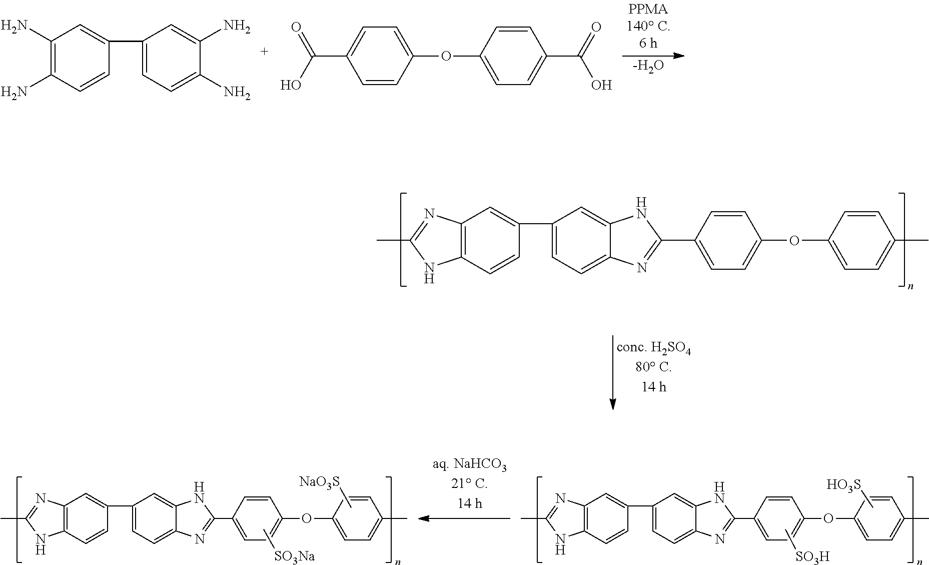

A 500 mL 4-neck kettle flask was assembled with a gas-inlet adapter, thermometer adapter, glass stopper, and a rubber stopper with a 9 mm bored hole. The gas inlet adapter was attached to an argon gas source. Through the thermometer adapter was inserted a thermometer (max. temp. 250° C.). Through the rubber stopper was inserted a dissolver stirrer shaft. The dissolver stirrer shaft was attached to an overhead stirrer. The flask'assembly was purged with argon gas for 45 minutes. This assembly rested on a heating mantle and was surrounded by a sand bath. The glass stopper was removed and to the kettle flask was added, under a positive argon flow, 1.04 g (4.0 mmol) of 4,4′-oxybis(benzoic acid), 0.86 g (4.0 mmol) of 3,3′-diaminobenzidine, and 150 mL of PPMA (phosphorus pentoxide/methane sulfonic acid) (Eaton, P. E.; Carlson, G. R. J. Org. Chem. 1973, 38, 4071-4073)³. The heating mantle was connected to a variable power controller. The mixture was stirred, via the overhead stirrer at 190 rpm, and heated to 140° C., via the heating mantle, for 6 hours.

After 6 hours, the flask's contents had become a very viscous polymer solution. The solution was slowly poured into 700 mL of ice water held in a 1 L beaker, with rapid stirring, via a magnetic stir bar and stirring plate. This mixture was rapidly stirred for 1 hour and then a precipitated polymer was collected by filtration. Resulting orange fibrous solid was washed with 100 mL of distilled water, collected, then soaked in 400 mL of 1 M aqueous potassium hydroxide for 10 hours. The soaking mixture was then neutralized to pH 7 with 1 M aqueous hydrochloric acid. Orange fibrous solid was then collected by filtration, washed with 100 mL of distilled water, and dried in a vacuum oven (1 mmHg) set at 110° C. for 16 hours.

Resulting dried dark orange fibrous solid was dissolved in 100 mL of concentrated sulfuric acid, in a 250 mL round bottom flask, and heated to 80° C. for 6 hours. This viscous red polymer solution was then slowly poured into 700 mL of ice water with rapid stirring. The mixture was rapidly stirred for 1 hour and then the precipitated polymer was collected by filtration. Resulting orange fibrous polymer was washed with 100 mL of distilled water, collected, then soaked in 400 mL of 2 M aqueous sodium bicarbonate for 10 hours. The orange fibrous solid was then collected by filtration, washed with 100 mL of distilled water, and dried in a vacuum oven (1 mmHg) set at 110° C. for 16 hours.

The resulting dried dark orange solid was combined with 40 mL of dimethylsulfoxide in a 150 mL round bottom flask equipped with a reflux condenser. This mixture was heated at 160° C. with magnetic stirring for 16 hours or until all solids were dissolved. The very viscous red polymer solution was then poured into a 15 cm round petri dish and then heated on a heating plate at 80° C., in an open atmosphere, for 5 hours or until the solution volume was reduced to approximately 25% the original volume. The petri dish containing the concentrated polymer solution was then heated in a vacuum oven (1 mmHg) at 120° C. for 16 hours.

An orange thin film of polybenzimidazole polymer was carefully peeled from the glass and soaked in 1 M aqueous sulfuric acid at 80° C. for 10 h. The orange film was then soaked in distilled water for 1 hour and then further dried in a vacuum oven (1 mmHg) at 120° C. for 16 hours.

TABLE 1
Structural formulae of dehydrogenation/hydrogenation pairs

| X^{H} | X |
|---|---|
| 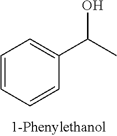 | 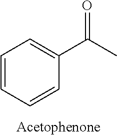 |
| 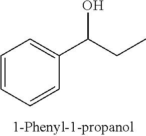 | 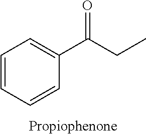 |
| 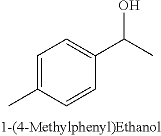 | 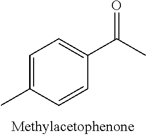 |
| 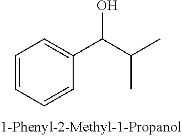 | 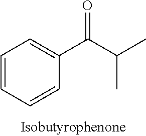 |
| 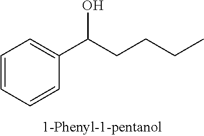 | 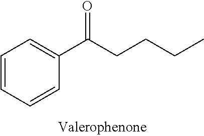 |
| 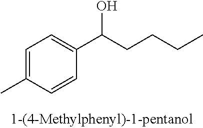 | 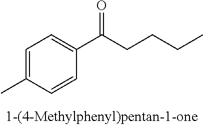 |

TABLE 2
Experimental results of catalyst/liquid pairs exhibiting preferred selectivity levels

| | | | % Selectivities² | | |
|---|---|---|---|---|---|
| Compound | Reaction | % Conversion² | Product | Side products | Reaction Conditions |
| 1-Phenyl-1-ethanol | Dehydrogenation¹ | 57.1% | ≧99% | Not Detected | 1 hour, 200° C., H₂ atmosphere, |
| Acetophenone | Hydrogenation¹ | 4.9% | ≧99% | Not Detected | 2 hour, 100° C., H₂ atmosphere |
| 1-Phenyl-1-propanol | Dehydrogenation¹ | 51.2% | ≧99% | Not Detected | 1 hour, 200° C., H₂ atmosphere |
| Propiophenone | Hydrogenation³ | 79.0% | ≧99% | Not Detected | 6 hours, 100° C., H₂ atmosphere |
| 1-Phenyl-1-Propanol | Dehydrogenation¹ | 69.0% | ≧99% | Not Detected | 4 hours, 200° C., H₂ atmosphere |
| 1-(4-MethylPhenyl)Ethanol | Dehydrogenation¹ | 45.3% | ≧99% | Not Detected | 1 hour, 200° C., H₂ atmosphere |
| Methylacetophenone | Hydrogenation¹ | 42.5% | ≧99% | Not Detected | 2 hour, 100° C., H₂ atmosphere |
| 1-Phenyl-2-Methyl-1-Propanol | Dehydrogenation¹ | 61.2% | ≧99% | Not Detected | 1 hour, 235° C., H₂ atmosphere |
| Isobutyrophenone | Hydrogenation¹ | 42.2% | ≧99% | Not Detected | 2 hour, 100° C., H₂ atmosphere |

¹Dehydrogenations were run using 0.1 mol % loading of 5% Pd on SiO₂. Hydrogenations were run using 1 mol % loading of 5% Pd on SiO₂
²Numbers are an average of two identical runs and were determined by ¹H NMR spectroscopy.
³0.1 mol % 5 wt % Pd on C was used

TABLE 3
Results of dehydrogenation of selected candidate fluids X^{H} or hydrogenation of rejected candidate fluids X

| Compound | Catalyst | | Reaction | Product(s) |
|---|---|---|---|---|
| N-methylindole | Pd/C | | hydrogenation | N/A N-methylindoline |
| | | | | N/A N-methylindole |
| 2,3-benzofuran | Pd/C | | hydrogenation | >99%* 2,3-dihydrobenzofuran |
| | | | | N/D 2,3-benzofuran |
| propiophenone | Pd/C | | hydrogenation | 79% 1-phenyl-1-propanol |
| | | | | 21% propiophenone* |
| 2,3-dihydrobenzofuran | Pd/C | | dehydrogenation | 18% 2,3-dihydrobenzofuran |
| | | | | 48% 2,3-benzofuran |
| | | | | 34% 2-ethylphenol |
| 1-phenyl-1-propanol | Pd/C | (10 wt %) | dehydrogenation | 13% 1-phenyl-1-propanol |
| | | | under H₂ gas | 57% propiophenone |
| | | | | 30% propylbenzene |
| 1-phenyl-1-propanol | Pd/Al₂O₃ | (5 wt %) | dehydrogenation | 19% 1-phenyl-1-propanol |
| | | | under H₂ gas | 69% propiophenone |
| | | | | 12% propylbenzene |
| 1-phenyl-1-propanol | Ni/kieselguhr | (~60 wt %) | dehydrogenation | 50% Unreacted Starting Material; |
| | | | under H₂ gas | 28% Propiophenone; |
| | | | | 19% Propylbenzene; |
| | | | | 4% Volatile Losses |
| 1-phenyl-1-propanol | Pd/C | (10 wt %) | dehydrogenation | 23% Unreacted Starting Material; |
| | | | under H₂ gas | 62% Propiophenone; |
| | | | | 12% Propylbenzene; |
| | | | | 4% Volatile Losses |
| 1-phenyl-1-propanol | Pd/Al₂O₃ | (5 wt %) | dehydrogenation | 34% Unreacted Starting Material; |
| | | | under H₂ gas | 59% Propiophenone; |
| | | | | 2% Propylbenzene; |
| | | | | 5% Volatile Losses |
| 1-phenyl-1-propanol | Pt/C | (5 wt %) | dehydrogenation | 53% Unreacted Starting Material; |
| | | | under H₂ gas | N/A % Propiophenone; |
| | | | | 15% Propylbenzene; |
| | | | | N/A % Volatile Losses |

| | | | |
|---|---|---|---|
| ethylene glycol | over 0.1 mol % of 5 wt % | dehydrogenation | 100% Starting Material; |
| | Pd/SiO₂ | under H₂ gas | 0% Product by loss of 2H (glycolaldehyde); |
| 1,2-propanediol | over 0.1 mol % of 5 wt % | dehydrogenation | 99% Starting Material; |
| | Pd/SiO₂ | under H₂ gas | 1% product by loss of 2H (hydroxyacetone |
| | | | and lactaldehyde) |
| 2,3-butanediol | over 0.1 mol % of 5 wt % | dehydrogenation | 97% Starting Material; |
| | Pd/SiO₂ | under H₂ gas | 3% product by loss of 2H (acetoin) |
| 1,3-propanediol | over 0.1 mol % of 5 wt % | dehydrogenation | N/A % Starting Material; |
| | Pd/SiO₂ | under H₂ gas | N/A % product by loss of 2H (3- |
| | | | hydroxypropanal) |
| 1,3-butanediol | over 0.1 mol % of 5 wt % | dehydrogenation | >99% Starting Material; |
| | Pd/SiO₂ | under H₂ gas | N/D % product by loss of 2H (3- |
| | | | hydroxybutanal and 4-hydroxy-2-butanonone) |
| 2,4-pentanediol | over 0.1 mol % of 5 wt % | dehydrogenation | N/A % Starting Material; |
| | Pd/SiO₂ | under H₂ gas | N/A % product by loss of 2H (4-hydroxy-2- |
| | | | pentanone) |
| ethylene glycol | over 0.1 mol % of 5 wt % | dehydrogenation | N/A % Starting Material; |
| | Ru/Al₂O₃ | under H₂ gas | N/A % product by loss of 2H (glycolaldehyde) |
| 1,2-propanediol | over 0.1 mol % of 5 wt % | dehydrogenation | 99% Starting Material; |
| | Ru/Al₂O₃ | under H₂ gas | 1% product by loss of 2H (hydroxyacetone |
| | | | and lactaldehyde) |
| 2,3-butanediol | over 0.1 mol % of 5 wt % | dehydrogenation | 96% Starting Material; |
| | Ru/Al₂O₃ | under H₂ gas | 4% product by loss of 2H (acetoin) |
| 1,3-propanediol | over 0.1 mol % of 5 wt % | dehydrogenation | N/A % Starting Material; |
| | Ru/Al₂O₃ | under H₂ gas | N/A % product by loss of 2H (3- |
| | | | hydroxypropanal) |
| 1,3-butanediol | over 0.1 mol % of 5 wt % | dehydrogenation | N/A % Starting Material; |
| | Ru/Al₂O₃ | under H₂ gas | N/A % product by loss of 2H (3- |
| | | | hydroxybutanal |
| | | | and 4-hydroxy-2-butanonone) |
| 2,4-pentanediol | over 0.1 mol % of 5 wt % | dehydrogenation | N/A % Starting Material; |
| | Ru/Al₂O₃ | under H₂ gas | N/A % product by loss of 2H (4-hydroxy-2- |
| | | | pentanone) |
| benzyl alcohol | over 0.1 mol % of 5 wt % | dehydrogenation | 97% Starting Material; |
| | Pd/SiO₂ | under H₂ gas | 3% Dehydrogenation Product |
| | | | (benzaldehyde); |
| | | | N/D % Hydrogenolysis Product (toluene) |
| benzyl amine | over 0.1 mol % of 5 wt % | dehydrogenation | N/A % Starting Material; |
| | Pd/SiO₂ | under H₂ gas | N/A % Dehydrogenation Product (benzimine); |
| | | | N/A % Hydrogenolysis Product (toluene) |
| benzyl aniline | over 0.1 mol % of 5 wt % | dehydrogenation | 99% Starting Material; |
| | Pd/SiO₂ | under H₂ gas | 1% Dehydrogenation Product (N- |
| | | | benzylideneaniline); |
| | | | N/D % Hydrogenolysis Product (toluene) |
| α-methylbenzyl alcohol | over 0.1 mol % of 5 wt % | dehydrogenation | 51% Starting Material; |
| | Pd/SiO₂ | under H₂ gas | 49% Dehydrogenation Product |
| | | | (acetophenone); |
| | | | N/D % Hydrogenolysis Product (ethylbenzene) |
| α-methylbenzyl amine | over 0.1 mol % of 5 wt % | dehydrogenation | N/A % Starting Material; |
| | Pd/SiO₂ | under H₂ gas | N/A % Dehydrogenation Product |
| | | | (acetophenone imine); |
| | | | N/A % Hydrogenolysis Product (ethylbenzene); |
| α-methylbenzyl aniline | over 0.1 mot % of 5 wt % | dehydrogenation | >99% Starting Material; |
| | Pd/SiO₂ | under H₂ gas | N/D % Dehydrogenation Product (N-(1-phenyl- |
| | | | ethylidene)aniline); |
| | | | N/D % Hydrogenolysis Product (ethylbenzene) |
| benzyl alcohol | over 0.1 mol % of 5 wt % | dehydrogenation | N/A % Starting Material; |
| | Ru/Al₂O₃ | under H₂ gas | N/A % Dehydrogenation Product |
| | | | (benzaldehyde); |
| | | | N/A % Hydrogenolysis Product (toluene) |
| benzyl amine | over 0.1 mol % of 5 wt % | dehydrogenation | N/A % Starting Material; |
| | Ru/Al₂O₃ | under H₂ gas | N/A % Dehydrogenation Product (benzimine); |
| | | | N/A % Hydrogenolysis Product (toluene) |
| benzyl aniline | over 0.1 mol % of 5 wt % | dehydrogenation | N/A % Starting Material; |
| | Ru/Al₂O₃ | under H₂ gas | N/A % Dehydrogenation Product |
| | | | (N-benzylideneaniline); |
| | | | N/A % Hydrogenolysis Product (toluene) |
| α-methylbenzyl alcohol | over 0.1 mol % of 5 wt % | dehydrogenation | 86% Starting Material; |
| | Ru/Al₂O₃ | under H₂ gas | 10% Dehydrogenation Product |
| | | | (acetophenone); |
| | | | 4% Hydrogenolysis Product (ethylbenzene) |
| α-methylbenzyl amine | over 0.1 mol % of 5 wt % | dehydrogenation | >99% Starting Material; |
| | Ru/Al₂O₃ | under H₂ gas | N/D % Dehydrogenation Product |
| | | | (acetophenone imine); |
| | | | N/D % Hydrogenolysis Product (ethylbenzene) |
| α-methylbenzyl aniline | over 0.1 mol % of 5 wt % | dehydrogenation | >99% Starting Material; |
| | Ru/Al₂O₃ | under H₂ gas | N/D % Dehydrogenation Product (N-(1-phenyl- |
| | | | ethylidene)aniline); |
| | | | N/D % Hydrogenolysis Product (ethylbenzene) |
| 1-phenyl-1-propanol | 5% Pd/CaCO₃ | dehydrogenation | 52% 1-phenyl-1-propanol |
| | | under H₂ gas | 45% propiophenone |
| | | | 3% propylbenzene |
| | | | N/D Unidentified product |
| 1-phenyl-1-propanol | 5% Pd/CaCO₃ Pb | dehydrogenation | 73% 1-phenyl-1-propanol |
| | | under H₂ gas | 27% propiophenone |
| | | | N/D propylbenzene |
| | | | N/D Unidentified product |
| 1-phenyl-1-propanol | 5% Pd/BaSO₄ | dehydrogenation | 29% 1-phenyl-1-propanol |
| | | under H₂ gas | 55% propiophenone |
| | | | 16% propylbenzene |
| | | | N/D Unidentified product |
| 1-phenyl-1-propanol | 5% Pd/BaCO₃ | dehydrogenation | 73% 1-phenyl-1-propanol |
| | | under H₂ gas | 27% propiophenone |
| | | | N/D propylbenzene |
| | | | N/D Unidentified product |
| 1-phenyl-1-propanol | 5% Pd/BaCO₃ (H₂O sat) | dehydrogenation | 69% 1-phenyl-1-propanol |
| | | under H₂ gas | 30% propiophenone |
| | | | 1% propylbenzene |
| | | | N/D Unidentified product |
| 1-phenyl-1-propanol | 5% Pd/Al₂O₃ | dehydrogenation | 49% 1-phenyl-1-propanol |
| | | under H₂ gas | 50% propiophenone |
| | | | 0.6% propylbenzene |
| | | | 0.7% Unidentified product |
| 1-phenyl-1-propanol | 1% Pd/Polyethylenimine | dehydrogenation | 62% 1-phenyl-1-propanol |
| | SiO₂ | under H₂ gas | 38% propiophenone |
| | | | N/D propylbenzene |
| | | | N/D Unidentified product |
| 1-phenyl-1-propanol | 3% Pd/Polyethylenimine | dehydrogenation | 51% 1-phenyl-1-propanol |
| | SiO₂ | under H₂ gas | 45% propiophenone |
| | | | 4% propylbenzene |
| | | | 0.1% Unidentified product |
| 1-phenyl-1-propanol | 5% Pt/SiO₂ | dehydrogenation | 88% 1-phenyl-1-propanol |
| | | under H₂ gas | 13% propiophenone |
| | | | N/D propylbenzene |
| | | | N/D Unidentified product |
| 1-phenyl-1-propanol | 10% Pt/Al₂O₃ | dehydrogenation | 50% 1-phenyl-1-propanol |
| | | under H₂ gas | 47% propiophenone |
| | | | 1.6% propylbenzene |
| | | | 0.8% Unidentified product |
| 1-phenyl-1-propanol | 5% Pt/CaCO₃ | dehydrogenation | 19% 1-phenyl-1-propanol |
| | | under H₂ gas | 64% propiophenone |
| | | | 2% propylbenzene |
| | | | 14% Unidentified product |
| 1-phenyl-1-propanol | 10% Pt/C | dehydrogenation | 33% 1-phenyl-1-propanol |
| | | under H₂ gas | 56% propiophenone |
| | | | 2% propylbenzene |
| | | | 9% Unidentified product |
| 1-phenyl-1-propanol | 10% Pt/10% Ir Mesh | dehydrogenation | 98% 1-phenyl-1-propanol |
| | Wire | under H₂ gas | 2.1% propiophenone |
| | | | N/D propylbenzene |
| | | | N/D Unidentified product |
| 1-phenyl-1-propanol | 0.5% Rh/Al₂O₃ | dehydrogenation | 35% 1-phenyl-1-propanol |
| | | under H₂ gas | 55% propiophenone |
| | | | 9.4% propylbenzene |
| | | | 0.7% Unidentified product |
| 1-phenyl-1-propanol | 5% Rh/C | dehydrogenation | 39% 1-phenyl-1-propanol |
| | | under H₂ gas | 56% propiophenone |
| | | | 3.4% propylbenzene |
| | | | 1.6% Unidentified product |
| 1-phenyl-1-propanol | 5% Rh/Al₂O₃ | dehydrogenation | 25% 1-phenyl-1-propanol |
| | | under H₂ gas | 64% propiophenone |
| | | | 9.5% propylbenzene |
| | | | 1.1% Unidentified product |
| 1-phenyl-1-propanol | 5% Ru/Al₂O₃ | dehydrogenation | 87% 1-phenyl-1-propanol |
| | | under H₂ gas | 11% propiophenone |
| | | | 2.2% propylbenzene |
| | | | 0.3% Unidentified product |
| 1-phenyl-1-propanol | 0.5% Ru/Al₂O₃ | dehydrogenation | 85% 1-phenyl-1-propanol |
| | | under H₂ gas | 13% propiophenone |
| | | | 2.5% propylbenzene |
| | | | N/D Unidentified product |
| 1-phenyl-1-propanol | 5% RU/C | dehydrogenation | 65% 1-phenyl-1-propanol |
| | | under H₂ gas | 25% propiophenone |
| | | | 10% propylbenzene |
| | | | 0.1% Unidentified product |
| 1-(4-MethyoxyPhenyl) | 5% Pd on SiO₂ | Dehydrogenation | 76% 1-(4-methoxyphenyl)ethanol |
| Ethanol | | | 19% 4-methoxyacetophenone |
| | | | 4.9% 4-ethylanisole |
| MethoxyAcetophenone | 5% Pd on SiO₂ | Hydrogenation | ≧99% Hydrogenation Product; |
| | | | N/D Hydrogenolysis Product |
| 1-phenyl-1-propanol | Pd/C | Dehydrogenation | >99%* propiophenone |
| | | Under Argon | |

*No other organic product was observed by ¹H NMR spectroscopy.
All quantities determined by ¹H NMR spectroscopy.
N/A is not determined. N/D is non-detectable.

TABLE 4
Results of dehydrogenations of 1-phenyl-1-
propanol performed as described in Example 9.

| Catalyst | | | | |
|---|---|---|---|---|
| wt % Pd | wt % Se | wt % SiO₂ | Conversion (%) | Selectivity (%) |
| 5 | 0 | 95 | 68 ± 2 | 88 ± 1 |
| 5 | 0.2 | 95 | 68 ± 3 | 98 ± 1 |
| 5 | 1.6 | 94 | 65 ± 1 | 90 ± 2 |
| 5 | 8 | 88 | 2.5 ± 0.6 | 89 ± 12 |

TABLE 5
Catalyst Screening in Dehydrogenation
of 1-phenyl-1-pentanol at 245° C.

| | | % Selectivities | | |
|---|---|---|---|---|
| | | | | Ring |
| | % Con- | | Hydro- | Hydro- |
| Catalyst | version | Product | genolysis | genation |
| 5% Pd on CaCO₃•Pb | 67.8 | 99.4 | 0.6 | 0 |
| 5% Pd on BaCO₃ | 73.9 | 97.7 | 1.5 | 0.8 |
| 5% Pt on SiO₂ | 44 | 92.2 | 5.2 | 2.6 |
| 5% Pd on SiO₂ | 85.8 | 94.2 | 5.8 | 0.8 |
| 1% Pd on PEI | 45.9 | 99.2 | 0.8 | 0 |

TABLE 6
Catalyst Screening in Dehydrogenation
of 1-phenyl-1-pentanol at 230° C.

| | | % Selectivities | | |
|---|---|---|---|---|
| | | | | Ring |
| | % Con- | | Hydro- | Hydro- |
| Catalyst | version | Product | genolysis | genation |
| 5% Pd on CaCO₃•Pb | 52 | 99.5 | 0.4 | 0.1 |
| 1% Pd on PEI | 16.5 | 99.9 | 0.1 | 0.0 |

TABLE 7
Catalyst Screening in Dehydrogenation of
1-phenyl-2-methyl-1-pentanol at 220° C.

% Selectivities

| | | | | Ring |
|---|---|---|---|---|
| | % Con- | | Hydro- | Hydro- |
| Catalyst | version | Product | genolysis | genation |
| 1% Pd on PEI | 6.1 | 96.2 | 0 | 3.8 |

TABLE 8
Results of the hydrogenation of para-substituted propiophenones
at 100° C. for 1 h under 1 atm of H₂ over 1 mol % Pd on SiO₂.

| para substituent | σₚₐᵣₐ | Conversion (%) | Selectivity (%) |
|---|---|---|---|
| CH₃ | −0.07 | 3.1 | >99.9 |
| H | 0 | 5.4 | >99.9 |
| OCH₃ | 0.12 | 6.6 | >99.9 |
| CF₃ | 0.43 | 44 | >99.9 |

1. A method of power generation comprising:
providing a closed system comprising:
(a) a dehydrogenation reactor that holds a catalyst and a liquid that comprises X^{H} and X;
(b) a fuel cell that comprises a membrane electrode assembly that comprises an anode, a cathode, and a polymer electrolyte membrane in functional contact with both the anode and the cathode; and
(c) means for circulating fluid between the dehydrogenation reactor and the fuel cell;
heating the dehydrogenation reactor to a first temperature effective to form (a) a gaseous product that comprises H₂ and (b) a liquid product mixture that is enriched in X;
heating the fuel cell to a second temperature effective to form a liquid product mixture that is enriched in X^{H} and to generate current, wherein the second temperature is substantially lower than the first temperature;
circulating the liquid product mixture that is enriched in X from the dehydrogenation reactor to the cathode;
circulating the gaseous product of the dehydrogenation reactor to the anode; and
circulating the resulting liquid product mixture that is enriched in X^{H} from the fuel cell to the dehydrogenation reactor;
wherein thermal energy is converted into electric energy via said dehydrogenation/hydrogenation and electric current is produced by the closed system; and
wherein the dehydrogenation/hydrogenation is reversible.

2. A power generator comprising:
a housing;
a dehydrogenation reactor that holds a catalyst and a liquid that comprises X^{H} and X;
a fuel cell that comprises a membrane electrode assembly that comprises an anode, a cathode, and a polymer electrolyte membrane that is in functional contact with the anode and the cathode; and
means for circulating a dehydrogenation products from the dehydrogenation reactor to the fuel cell and for circulating hydrogenation products from the fuel cell to the dehydrogenation reactor;
wherein the, power generator is a closed system; and
wherein when the dehydrogenation reactor is heated to a first temperature effective to form (a) a gaseous product comprising H₂ and (b) a liquid product mixture that is enriched in X, and the fuel cell is heated to a second temperature effective to form a liquid product mixture that is enriched in X^{H}, the first temperature being substantially higher than the second temperature, then thermal energy is converted into electric energy via reversible dehydrogenation/hydrogenation and electric current is produced.

3. The power generator of claim 2, wherein substantially all of the X^{H} that is dehydrogenated forms X and H₂.

4. (canceled)

5. A method of dehydrogenating a secondary benzylic alcohol in a H₂-rich environment, comprising:
contacting a secondary benzylic alcohol with Pd on SiO₂ in a closed H₂-rich environment at about 200° C.

6. The power generator of claim 2, wherein X^{H} comprises a secondary benzylic alcohol.

7. The power generator of claim 6, wherein X^{H} comprises a compound of formula (1) 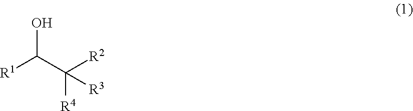
where R¹ is a substituted or unsubstituted aryl (which includes heteroaryl comprising N, O, and/or S);
R², R³ and R⁴ are independently hydrogen, aliphatic, aryl, OH, OR⁵, Si, NH, NHR⁵, NR⁵R⁶, B, and may be substituted but do not include moieties that poison catalysts or that are reactive in the presence of catalyst or H₂;
R⁵ and R⁶ are independently hydrogen, aliphatic, aryl, or a combination thereof; and
where any combination of R², R³ and R⁴ together with the carbon atom to which they are attached, can optionally form a cyclic moiety, and R⁵ and R⁶ together with the nitrogen atom to which they are attached, can optionally form a cyclic moiety.

8. (canceled)

9. The power generator of claim 7, wherein R¹ is a substituted or unsubstituted moiety selected from phenyl, pyridyl, pyrimidinyl, pyrazinyl, triazinyl, furyl, thiophenyl, imidazolyl, oxazolyl, pyrrolyl, naphthyl, quinolinyl, isoquinolyl, indenyl, indolyl, and benzothiophenyl.

10. The power generator of claim 2, wherein X^{H} comprises 1-phenyl-1-ethanol, 1-phenyl-1-propanol, 1-(4-methylphenyl)ethanol, 1-phenyl-2-methyl-1-propanol, or a combination thereof.

11. The power generator of claim 2, wherein X^{H} comprises 1-phenyl-1-propanol, which dehydrogenates to form propiophenone and H₂.

12. The power generator of claim 2, wherein X^{H} comprises 1-phenyl-1-ethanol, which dehydrogenates to form acetophenone and H₂.

13. The power generator of claim 2, wherein the heating of the dehydrogenation reactor to a first temperature and the heating of the fuel cell to a second temperature is by solar heat, waste heat, or geothermal heat.

14. The power generator of claim 2, wherein the first temperature is about 140 to about 300° C. and the first temperature is at least about 50° higher than the second temperature.

15. The power generator of claim 2, wherein the first temperature is about 180 to about 250° C. and the first temperature is at least about 50° higher than the second temperature.

16. The power generator of claim 2, wherein the second temperature is about 70 to about 160° C. and the second temperature is at least about 50° lower than the first temperature.

17. The power generator of claim 2, wherein the second temperature is about 80 to about 105° C. and the second temperature is at least about 50° lower than the first temperature.

18. The power generator of claim 2, wherein the catalyst is palladium on SiO₂.

19. The power generator of claim 18, wherein the catalyst is 5% palladium relative to SiO₂.

20. The power generator of claim 7, wherein R¹ is a substituted or unsubstituted heteroaryl moiety.

21. The power generator of claim 20, wherein the ring atom of R¹ that links to the alcohol moiety is a carbon.

22. The method of claim 1, wherein the catalyst comprises Pd on carbon, Pt on carbon, or a combination thereof.

23. The method of claim 1, wherein the polymer electrolyte membrane comprises sulfonated polybenzimidazole.

24. The method of claim 23, wherein the sulfonated polybenzimidazole comprises 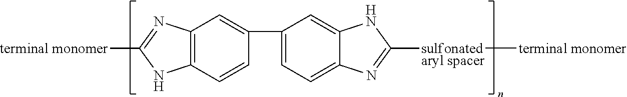
where n is a very large number, terminal monomer refers to the appropriate mono-linked carboxylic or diamino monomers, and non-limiting examples of sulfonated aryl spacers include:

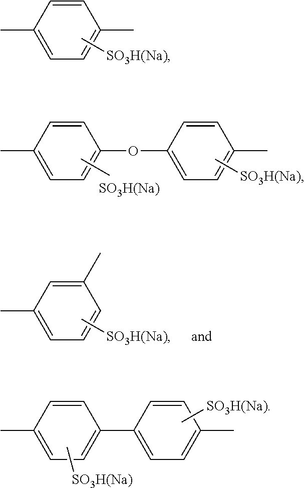

25. The power generator of claim 2, wherein the second temperature is about 120° C. to about 160° C.
